(19) United States
(12) Patent Application Publication
(10) Pub. No.: US 2025/0338287 A1
(43) Pub. Date: Oct. 30, 2025

(54) CROSS-CARRIER SCHEDULING IN UNIFIED TRANSMISSION CONFIGURATION INDICATOR FRAMEWORKS

(71) Applicant: QUALCOMM INCORPORATED, San Diego, CA (US)

(72) Inventors: Fang Yuan, Beijing (CN); Yan Zhou, San Diego, CA (US); Mostafa Khoshnevisan, San Diego, CA (US); Tao Luo, San Diego, CA (US)

(21) Appl. No.: 18/869,800

(22) PCT Filed: Aug. 3, 2022
(86) PCT No.: PCT/CN2022/109888

§ 371 Date: Nov. 26, 2024

(51) Int. Cl. H04W 72/232; H04L 5/00; H04W 72/1263

(52) U.S. Cl. CPC H04W 72/232; H04L 5/001; H04W 72/1263

(57) ABSTRACT

Methods, systems, and devices for wireless communications are described. A user equipment (UE) may receive control signaling on a first component carrier that indicates a first transmission configuration indicator (TCI) state and a grant of resources for receiving a data transmission or an aperiodic channel state information (A-CSI) transmission on a second component carrier that is different from the first component carrier. The UE may determine whether a first physical cell identifier (PCI) associated with the first TCI state and a second PCI associated with a serving cell of the second component carrier are the same. The UE may select the first TCI state based on the first and second PCI being the same or the first TCI corresponding to a low index value. The UE may receive, via the first TCI state, the data transmission or the A-CSI via the second component carrier according to the grant of resources.

### CROSS REFERENCE

The present application is a 371 national stage filing of International PCT Application No. PCT/CN2022/109888 by Yuan et al. entitled “CROSS-CARRIER SCHEDULING IN UNIFIED TRANSMISSION CONFIGURATION INDICATOR FRAMEWORKS,” filed Aug. 3, 2022, which is assigned to the assignee hereof, and which is expressly incorporated by reference in its entirety herein.

### FIELD OF TECHNOLOGY

The following relates to wireless communications, including cross-carrier scheduling in unified transmission configuration indicator frameworks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). In some wireless communications systems, a UE may operate in a unified transmission configuration indicator (TCI) framework.

### SUMMARY

The described techniques relate to improved methods, systems, devices, and apparatuses that support cross-carrier scheduling in unified transmission configuration indicator (TCI) frameworks. For example, the described techniques provide for a user equipment (UE) to select a default TCI state during cross carrier scheduling in the unified TCI framework, thereby reducing latency in some wireless communications and improving reliability of wireless communications. For example, the UE may receive control signaling on a first component carrier that indicates a first TCI state and a grant of resources for receiving a data transmission or an aperiodic channel state information (A-CSI) transmission on a second component carrier that is different from the first component carrier (e.g., cross-carrier scheduling). The UE may determine whether a first physical cell identifier (PCI) associated with the first TCI state in an active bandwidth part (BWP) of the second component carrier and a second PCI associated with a serving cell of the second component carrier are the same. In some cases, the UE may select the first TCI state based on the first PCI and the second PCI being the same, or may select the first TCI state because it corresponds to a lowest index value if the first PCI and the second PCI are not the same. The UE may receive, via the first TCI state, the data transmission, or the A-CSI transmission via the second component carrier according to the grant of resources.

A method for wireless communications at a UE is described. The method may include receiving control signaling on a first component carrier, the control signaling including an indication of a first TCI state and a grant of resources for receiving a data transmission or an A-CSI transmission on a second component carrier that is different from the first component carrier, determining whether a first PCI associated with the first TCI state in an active BWP of the second component carrier and a second PCI associated with a serving cell of the second component carrier are the same, and receiving, via the first TCI state based on the determining, the data transmission or the A-CSI transmission via the second component carrier according to the grant of resources.

An apparatus for wireless communications at a UE is described. The apparatus may include a processor, memory coupled with the processor, and instructions stored in the memory. The instructions may be executable by the processor to cause the apparatus to receive control signaling on a first component carrier, the control signaling including an indication of a first TCI state and a grant of resources for receiving a data transmission or an A-CSI transmission on a second component carrier that is different from the first component carrier, determine whether a first PCI associated with the first TCI state in an active BWP of the second component carrier and a second PCI associated with a serving cell of the second component carrier are the same, and receive, via the first TCI state based on the determining, the data transmission or the A-CSI transmission via the second component carrier according to the grant of resources.

Another apparatus for wireless communications at a UE is described. The apparatus may include means for receiving control signaling on a first component carrier, the control signaling including an indication of a first TCI state and a grant of resources for receiving a data transmission or an A-CSI transmission on a second component carrier that is different from the first component carrier, means for determining whether a first PCI associated with the first TCI state in an active BWP of the second component carrier and a second PCI associated with a serving cell of the second component carrier are the same, and means for receiving, via the first TCI state based on the determining, the data transmission or the A-CSI transmission via the second component carrier according to the grant of resources.

A non-transitory computer-readable medium storing code for wireless communications at a UE is described. The code may include instructions executable by a processor to receive control signaling on a first component carrier, the control signaling including an indication of a first TCI state and a grant of resources for receiving a data transmission or an A-CSI transmission on a second component carrier that is different from the first component carrier, determine whether a first PCI associated with the first TCI state in an active BWP of the second component carrier and a second PCI associated with a serving cell of the second component carrier are the same, and receive, via the first TCI state based on the determining, the data transmission or the A-CSI transmission via the second component carrier according to the grant of resources.

Some examples of the method, apparatuses, and non-transitory computer-readable medium described herein may further include operations, features, means, or instructions for determining that a duration of time between receiving the control signaling and the granted resources does not satisfy a threshold time period, where the first PCI and the second PCI may be not the same, identifying a set of multiple TCI states including the first TCI state activated for the second component carrier, each of the set of multiple TCI states corresponding to a respective index value of a set of multiple index values, and selecting the first TCI state from the set of multiple TCI states activated for the second component carrier based on the first TCI state corresponding to a lowest index value of the set of multiple index values and the duration of time not satisfying the threshold time period.

Some examples of the method, apparatuses, and non-transitory computer-readable medium described herein may further include operations, features, means, or instructions for receiving, in the control signaling, an indication of the set of multiple TCI states.

Some examples of the method, apparatuses, and non-transitory computer-readable medium described herein may further include operations, features, means, or instructions for applying the first TCI state to a set of multiple component carriers of a carrier aggregation configuration including the first component carrier and the second component carrier based on the first TCI state corresponding to the lowest index value of the set of multiple index values.

Some examples of the method, apparatuses, and non-transitory computer-readable medium described herein may further include operations, features, means, or instructions for receiving control signaling including an indication of the threshold time period.

Some examples of the method, apparatuses, and non-transitory computer-readable medium described herein may further include operations, features, means, or instructions for receiving control signaling enabling the UE to select a default TCI state for cross-carrier scheduling, where selecting the first TCI state may be based on receiving the control signaling enabling the UE to select the default TCI state for cross-carrier scheduling.

Some examples of the method, apparatuses, and non-transitory computer-readable medium described herein may further include operations, features, means, or instructions for selecting the first TCI state based on the determining, where the first PCI and the second PCI may be the same, and where receiving the data transmission or the A-CSI transmission may be based on the selecting.

In some examples of the method, apparatuses, and non-transitory computer-readable medium described herein, receiving the control signaling may include operations, features, means, or instructions for receiving a first downlink control information (DCI) message including the indication of the first TCI state and receiving a second DCI message including the grant of resources, where the first DCI message and the second DCI message support a unified TCI state configuration.

A method for wireless communications at a network entity is described. The method may include outputting control signaling on a first component carrier, the control signaling including an indication of a first TCI state and a grant of resources for outputting a data transmission or an A-CSI transmission on a second component carrier that is different from the first component carrier, determining whether a first PCI associated with the first TCI state in an active BWP of the second component carrier and a second PCI associated with a serving cell of the second component carrier are the same, and outputting, via a first beam associated with the first TCI state based on the determining, the data transmission or the A-CSI transmission via the second component carrier according to the grant of resources.

An apparatus for wireless communications at a network entity is described. The apparatus may include a processor, memory coupled with the processor, and instructions stored in the memory. The instructions may be executable by the processor to cause the apparatus to output control signaling on a first component carrier, the control signaling including an indication of a first TCI state and a grant of resources for outputting a data transmission or an A-CSI transmission on a second component carrier that is different from the first component carrier, determine whether a first PCI associated with the first TCI state in an active BWP of the second component carrier and a second PCI associated with a serving cell of the second component carrier are the same, and output, via a first beam associated with the first TCI state based on the determining, the data transmission or the A-CSI transmission via the second component carrier according to the grant of resources.

Another apparatus for wireless communications at a network entity is described. The apparatus may include means for outputting control signaling on a first component carrier, the control signaling including an indication of a first TCI state and a grant of resources for outputting a data transmission or an A-CSI transmission on a second component carrier that is different from the first component carrier, means for determining whether a first PCI associated with the first TCI state in an active BWP of the second component carrier and a second PCI associated with a serving cell of the second component carrier are the same, and means for outputting, via a first beam associated with the first TCI state based on the determining, the data transmission or the A-CSI transmission via the second component carrier according to the grant of resources.

A non-transitory computer-readable medium storing code for wireless communications at a network entity is described. The code may include instructions executable by a processor to output control signaling on a first component carrier, the control signaling including an indication of a first TCI state and a grant of resources for outputting a data transmission or an A-CSI transmission on a second component carrier that is different from the first component carrier, determine whether a first PCI associated with the first TCI state in an active BWP of the second component carrier and a second PCI associated with a serving cell of the second component carrier are the same, and output, via a first beam associated with the first TCI state based on the determining, the data transmission or the A-CSI transmission via the second component carrier according to the grant of resources.

Some examples of the method, apparatuses, and non-transitory computer-readable medium described herein may further include operations, features, means, or instructions for determining that a duration of time between outputting the control signaling and the granted resources does not satisfy a threshold time period, where the first PCI and the second PCI may be not the same, identifying a set of multiple beams associated with a set of multiple TCI states including the first TCI state activated for the second component carrier, each of the set of multiple TCI states corresponding to a respective index value of a set of multiple index values, and selecting the first beam associated with the first TCI state from the set of multiple TCI states activated for the second component carrier based on the first TCI state corresponding to a lowest index value of the set of multiple index values and the duration of time not satisfying the threshold time period.

Some examples of the method, apparatuses, and non-transitory computer-readable medium described herein may further include operations, features, means, or instructions for outputting, in the control signaling, an indication of the set of multiple TCI states.

In some examples of the method, apparatuses, and non-transitory computer-readable medium described herein, the first beam associated with the first configuration indicator state to a set of multiple component carriers of a carrier aggregation configuration including the first component carrier and the second component carrier based on the first TCI state corresponding to the lowest index value of the set of multiple index values.

Some examples of the method, apparatuses, and non-transitory computer-readable medium described herein may further include operations, features, means, or instructions for outputting control signaling including an indication of the threshold time period.

Some examples of the method, apparatuses, and non-transitory computer-readable medium described herein may further include operations, features, means, or instructions for outputting control signaling enabling a UE to select a default TCI state for cross-carrier scheduling, where selecting the first TCI state may be based on outputting the control signaling enabling the UE to select the default TCI state for cross-carrier scheduling.

Some examples of the method, apparatuses, and non-transitory computer-readable medium described herein may further include operations, features, means, or instructions for selecting the first beam associated with the first TCI state based on the determining, where the first PCI and the second PCI may be the same, and where the outputting the data transmission or the A-CSI transmission via the first beam may be based on the selecting.

In some examples of the method, apparatuses, and non-transitory computer-readable medium described herein, outputting the control signaling may include operations, features, means, or instructions for outputting a first DCI message including the indication of the first TCI state and outputting a second DCI message including the grant of resources, where the first DCI message and the second DCI message support a unified TCI state configuration.

### BRIEF DESCRIPTION OF THE DRAWINGS

FIG. 1 and FIG. 2 illustrate examples of wireless communications systems that support cross-carrier scheduling in unified transmission configuration indicator (TCI) frameworks in accordance with one or more aspects of the present disclosure.

FIG. 3 illustrates an example of a process flow that supports cross-carrier scheduling in unified TCI frameworks in accordance with one or more aspects of the present disclosure.

FIGS. 4 and 5 show block diagrams of devices that support cross-carrier scheduling in unified TCI frameworks in accordance with one or more aspects of the present disclosure.

FIG. 6 shows a block diagram of a communications manager that supports cross-carrier scheduling in unified TCI frameworks in accordance with one or more aspects of the present disclosure.

FIG. 7 shows a diagram of a system including a device that supports cross-carrier scheduling in unified TCI frameworks in accordance with one or more aspects of the present disclosure.

FIGS. 8 and 9 show block diagrams of devices that support cross-carrier scheduling in unified TCI frameworks in accordance with one or more aspects of the present disclosure.

FIG. 10 shows a block diagram of a communications manager that supports cross-carrier scheduling in unified TCI frameworks in accordance with one or more aspects of the present disclosure.

FIG. 11 shows a diagram of a system including a device that supports cross-carrier scheduling in unified TCI frameworks in accordance with one or more aspects of the present disclosure.

FIGS. 12 through 15 show flowcharts illustrating methods that support cross-carrier scheduling in unified TCI frameworks in accordance with one or more aspects of the present disclosure.

### DETAILED DESCRIPTION

In some wireless communications systems, a network entity may schedule downlink communications (e.g., data on a physical downlink shared channel (PDSCH) or aperiodic channel state information (A-CSI)) via cross-carrier scheduling. For example, the network entity may transmit downlink control information (DCI) on a first component carrier, that may schedule resources for a PDSCH or A-CSI on a different component carrier. The UE may also support a unified transmission configuration indicator (TCI) framework, in which the network entity may activate multiple TCI states (e.g., and where each activated TCI state may support multiple channels). For example, the network entity may activate a first TCI state, which may correspond to a beam that supports a PDSCH and a physical downlink control channel (PDCCH). Likewise, the network entity may activate a second TCI state, which may correspond to a beam that supports a physical uplink control channel (PUCCH) and a physical uplink shared channel (PUSCH). In some cases, the UE may be scheduled with resources for the downlink communications less than a threshold period of time after receiving the scheduling DCI. In such cases, the UE may not be able to decode the scheduling DCI and determine the TCI state to use in communications with the network entity (e.g., determine on which beam to receive data signaling via the PDSCH or the A-CSI). It may therefore be unclear to the UE which beam to utilize for receiving the scheduled data signaling on the PDSCH or the A-CSI.

However, some wireless communications systems may not support techniques for determining a default beam for the reception of the PDSCH or A-CSI transmission (e.g., in cases when the resources are scheduled prior to the threshold time duration in a unified TCI framework using cross-carrier scheduling). That is, in the case when the scheduling DCI is received in a first component carrier, where the DCI indicates a TCI state for a PDSCH or A-CSI on a second component carrier, and the resources for the PDSCH or A-CSI are received less than a threshold period of time after the scheduling DCI, then the UE may be unable to determine a default beam, leading to transmission failure, increased latency, less efficient use of available system resources, and degraded user experience, among other examples.

The techniques described herein may enable the UE to select a default beam in scenarios in cross-carrier scheduling scenarios under a unified TCI framework. For example, the UE may receive control signaling (e.g., two DCIs for a unified TCI framework) on a first component carrier indicating resources for a PDSCH or A-CSI on a different component carrier. In some cases, the UE may determine that a duration between receiving the resources for the PDSCH or A-CSI and receiving the control signaling does not satisfy a threshold time period.

In such cases, the UE may determine whether a physical cell identifier (PCI) of an activated TCI state in an active bandwidth part (BWP) of the second component carrier matches a PCI for a serving cell of the second component carrier. If a PCI associated with an active BWP of the second component carrier and a second PCI associated with a serving cell of the second component carrier are the same, then the UE may apply a TCI state indicated in the control signaling (e.g., indicated in a beam indicator DCI of a pair of DCIs for a unified TCI framework) regardless of whether the threshold time period is satisfied. However, if the PCIs do not match, and the PDSCH or A-CSI is scheduled within the threshold time period, the UE may select a default TCI state that has a lowest identifier (ID) of all activated TCI states (e.g., for both component carriers). Additionally, or alternatively, the UE may also apply a TCI state having a lowest ID value to all component carriers of a carrier aggregation. Thus, the UE may select a default beam for the PDSCH or A-CSI in a unified TCI framework during cross-carrier scheduling, which may reduce transmission failure and reduce latency in the wireless communications.

Aspects of the disclosure are initially described in the context of wireless communications systems. Aspects described herein may relate to a UE selecting a default beam during cross-carrier scheduling in a unified TCI framework. Aspects of the disclosure are further illustrated by and described with reference to apparatus diagrams, system diagrams, and flowcharts that relate to cross-carrier scheduling in unified TCI frameworks.

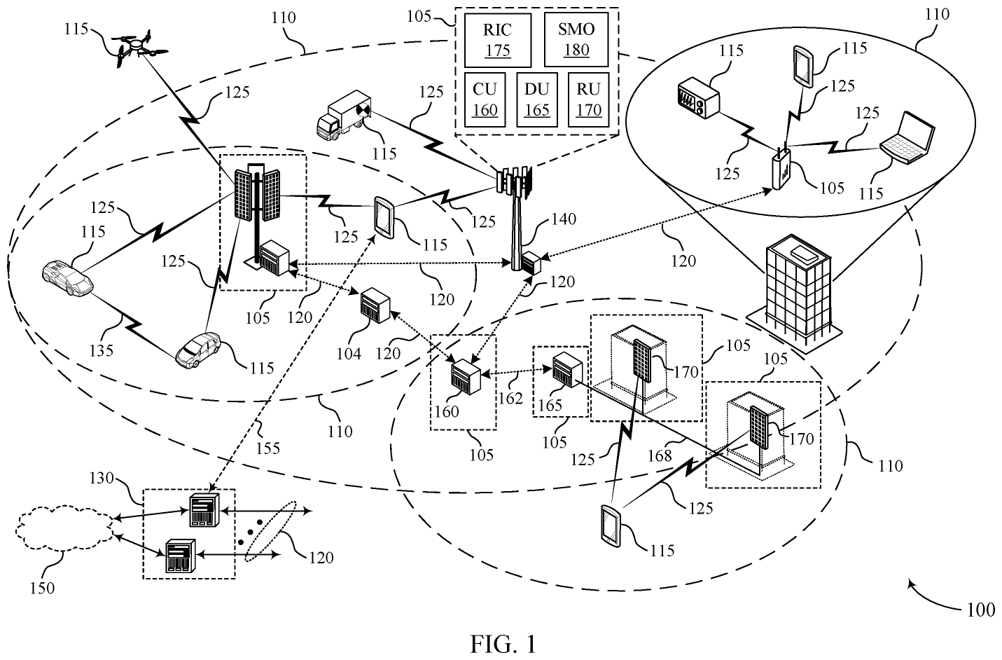

FIG. 1 illustrates an example of a wireless communications system 100 that supports cross-carrier scheduling in unified TCI frameworks in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support cross-carrier scheduling in unified TCI frameworks as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, the UE 115 may operate in a unified TCI framework. The unified TCI framework may correspond to three types of unified TCI frameworks. In a first type of the unified TCI framework, the UE 115 may receive a joint TCI state that indicates a common beam for at least one downlink channel (e.g., a PDCCH or a PDSCH) or reference signal and at least one uplink channel (e.g., a PUCCH, and a PUSCH) or reference signal. For example, the UE 115 may receive a TCI state that includes a beam to use for both the PDCCH and PUCCH, both the PDSCH and the PUSCH, both the PDCCH the PUSCH, the PUCCH and the PDSCH, or the like.

In a second type of the unified TCI framework, the UE 115 may receive a downlink TCI state to indicate a common beam for more than one downlink channels or reference signals. That is, the UE 115 may receive a TCI state that activates a beam for both a PDCCH and a PDSCH. In a third type of the unified TCI framework, the UE 115 may receive an uplink TCI state that indicates a common beam for more than one uplink channels or reference signals. For example, the UE 115 may receive a TCI state that indicates a beam for both a PUCCH and a PUSCH.

Using current techniques, the UE 115 may select a default beam for a PDSCH or an A-CSI in a non-unified TCI framework, in a non-unified TCI framework using cross-carrier scheduling, and in unified TCI frameworks. However, current techniques may not enable the UE 115 to select a default beam for a PDSCH or A-CSI in a unified TCI framework during cross-carrier scheduling. Thus, it may be advantageous (e.g., to clarify UE behavior) for the UE 115 to select and use a default beam to receive PDSCH or A-CSI in a unified TCI framework in cross-carrier scheduling.

Using current techniques, the UE 115 may receive DCI indicating a TCI state and/or granted resources for the PDSCH or A-CSI. In some cases, the DCI is received in a first component carrier and the PDSCH or A-CSI are scheduled for a second component carrier. In such cases, the UE 115 may determine if a scheduling offset, indicated in the received DCI, of the PDSCH or A-CSI is less than a predetermined threshold (e.g., scheduling offset is less than timeDurationForQCL) regardless of the TCI framework (e.g., regardless of the configuration of followUnifiedTCIstate for the A-CSI). That is, in a non-unified TCI framework, the UE 115 may determine if the granted resources for the PDSCH or A-CSI are scheduled before a predetermined threshold.

In some cases, the UE 115 may determine that the scheduling offset is less than the predetermined threshold. In such cases, the UE 115 may determine if the indicated TCI is associated with a PCI different from the serving cell PCI (e.g., inter-cell cross-carrier scheduling). If the UE 115 determines that the indicated TCI is associated with a PCI different from the serving cell PCI, the UE 115 may apply a default quasi co-location (QCL) assumption for both non-UE dedicated and UE dedicated PDSCH. That is, the UE 115 may apply a QCL assumption of the lowest ID in the latest slot. Additionally, in cases of inter-cell cross-carrier scheduling, the UE 115 may determine if the QCL-TypeD property for default beams in a slot for component carriers in an active BWP are different. If so, the UE 115 may select the default beam for the component carrier with lowest ID. That is, the selected default beam for the component carrier with lowest ID is applied to all the component carriers in the active BWP to use for the transmission of the PDSCH or the A-CSI.

Alternatively, if the UE 115 determines that the indicated TCI is associated with the same serving cell PCI (e.g., intra-cell cross carrier scheduling), the UE may select and use the default beam indicated in the TCI for both UE-dedicated and non-UE-dedicated PDSCHs or A-CSI. Thus, in the case of intra cell cross-carrier scheduling, the UE 115 may not consider the default QCL assumption. In some cases, the UE 115 may not expect to receive a non-UE dedicated PDSCH. For example, the UE 115 may not receive a non-UE dedicated PDSCH in cases when the source reference signal of the indicated TCI state of the corresponding PDSCH is not associated with the serving cell PCI.

In cases of cross-carrier scheduling in an non-unified TCI framework, the UE 115 may use the predetermined threshold to determine whether the DCI may be decoded or select a default beam. For example, if the UE 115 receives the PDCCH carrying the scheduling DCI on one component carrier and receives a PDSCH scheduled by that DCI is on another component carrier, the UE 115 may use the predetermined threshold (e.g., timeDurationForQCL) to determine whether the UE 115 may decode and receive the PDSCH or select a default beam. The network entity 105 may determine the threshold (e.g., timeDurationForQCL) based on the subcarrier spacing of the scheduled PDSCH and transmit the threshold to the UE 115. In some cases, if a PDCCH offset, μ_{PDCCH}, is less than a PDSCH offset, μ_{PDSCH} the UE 115 may add an additional timing delay,

$$d \frac{{2}^{{μ}_{PDSCH}}}{{2}^{{μ}_{PDCCH}}} ,$$

to the threshold (e.g., timeDurationForQCL) where d may be defined by the network entity 105, otherwise d is zero. In some cases, the UE 115 may be configured with a cross-carrier scheduling default beam parameter (e.g., enableDefaultBeamForCCS) if the offset between the reception of the downlink DCI and the corresponding PDSCH is less than the threshold (e.g., timeDurationForQCL) or if the downlink DCI does not have the TCI field present. In such cases, the UE 115 may obtain a QCL assumption for the scheduled PDSCH from the activated TCI state with the lowest ID applicable to PDSCH in the active BWP of the scheduled cell.

In some cases, the UE 115 may select a default beam during cross-carrier scheduling, where the A-CSI reporting or A-CSI reference signal (A-CSI-RS) corresponding to the triggering PDCCH, and the channel state information reference signal (CSI-RS) have the same numerology based on one or more conditions. For example, the UE 115 may select a default beam based on determining if the scheduling offset between the last symbol of the PDCCH carrying the triggering DCI and the first symbol of the aperiodic CSI-RS resources in a CSI-RS resource set (e.g., NZP-CSI-RS-ResourceSet), configured without higher layer parameter (e.g., trs-Info) is: smaller than the UE 115 reported beam switching threshold (e.g., beamSwitchTiming) when the reported value is one of the values of {14, 28, 48}·2^{max(0, μ}^{_{CSIRS}}⁻³⁾ and a beam switch enable parameter (e.g., enableBeamSwitchTiming) is not provided; or is smaller than 48·2^{max(0, μ}^{_{CSIRS}}⁻³⁾ when the UE 115 provides a beam switching threshold parameter (e.g., beamSwitchTiming-r16), the beam switch enable parameter (e.g., enableBeamSwitchTiming) is provided and the CSI-RS resource set (e.g., NZP-CSI-RS-ResourceSet) is configured with the higher layer parameter repetition set to off or configured without the higher layer parameter repetition; or is smaller than the UE 115 reported threshold beamSwitchTiming-r16 when the beam switching threshold parameter (e.g., enableBeamSwitchTiming) is provided and the CSI-RS resource set (e.g., NZP-CSI-RS-ResourceSet) is configured with the higher layer parameter repetition set to on.

Alternatively, the UE 115 may select a default beam based on determining if the UE 115 is configured with the cross-carrier scheduling default beam parameter (e.g., enableDefaultBeamForCCS) and, when receiving the aperiodic CSI-RS, the UE 115 may apply the QCL assumption of the lowest-ID activated TCI state applicable to the PDSCH within the active BWP of the cell in which the CSI-RS is to be received.

In some other cases, the UE 115 may select a default beam during cross-carrier scheduling, where the A-CSI reporting or A-CSI-RS corresponding to the triggering PDCCH, and the CSI-RS have different numerologies based on one or more conditions. For example, the UE 115 may select a default beam based on determining if the scheduling offset between the last symbol of the PDCCH carrying the triggering DCI and the first symbol of the aperiodic CSI-RS resources in a CSI-RS resource set (e.g., NZP-CSI-RS-ResourceSet) configured without a higher layer parameter (e.g., trs-Info) is: smaller than a beamSwitchTiming+d·2^{μ}^{_{CSIRS}}/2^{μ}^{_{PDCCH}} in CSI-RS symbols when the reported value is one of the values of {14, 28, 48}·2^{max(0, μ}^{_{CSIRS}}⁻³⁾ and the beam switching enable parameter (e.g., enableBeamSwitchTiming) is not provided; or is smaller than 48·2^{max(0, μ}^{_{CSIRS}}⁻³⁾+d·2^{μ}^{_{CSIRS}}/2^{μ}^{_{PDCCH}} in CSI-RS symbols when the UE provides a beam switching threshold parameter (e.g., beamSwitchTiming-r16) and the beam switching enable parameter (e.g., enableBeamSwitchTiming) is provided and the CSI-RS resource set (e.g., NZP-CSI-RS-ResourceSet) is configured with the higher layer parameter repetition set to off or configured without the higher layer parameter repetition; or is smaller than beamSwitchTiming-r16+d·2^{μ}^{_{CSIRS}}/2^{μ}^{_{PDCCH}} in CSI-RS symbols, when the beam switching enable parameter (e.g., enableBeamSwitchTiming) is provided and CSI-RS resource set (e.g., NZP-CSI-RS-ResourceSet) is configured with the higher layer parameter repetition set to ‘on’, where if the μ_{PDCCH}<μ_{CSIRS}, the beam switching timing delay d may be defined, else d is zero.

Additionally, the UE 115 may select a default beam for A-CSI reporting, when the A-CSI-RS and CSI-RS have different numerologies based on determining if one of the associated trigger states has a higher layer parameter (e.g., qcl-Type) set to ‘typeD’. If the higher layer parameter (e.g., qcl-Type) is set to ‘typeD,’ then the UE 115 may determine if there is any other downlink signal with an indicated TCI state in the same symbols as the CSI-RS, else if the UE 115 is configured with the cross-carrier scheduling default beam parameter (e.g., enableDefaultBeamForCCS), when receiving the aperiodic CSI-RS, the UE 115 may apply the QCL assumption of the lowest-ID activated TCI state applicable to the PDSCH within the active BWP of the cell in which the CSI-RS is to be received.

Thus, according to the techniques described above, the UE 115 may select a default beam for a PDSCH or an A-CSI in a non-unified TCI framework, in a non-unified TCI frameworks using cross-carrier scheduling, and in unified TCI frameworks when the resources for the PDSCH or the A-CSI are received less than a threshold period of time after receiving the scheduling DCI.

However, current techniques for determining a default beam may not support the case in which the PDSCH or A-CSI transmission is scheduled prior to the threshold time duration in a unified TCI framework for cross-carrier scheduling. That is, in the case when the scheduling DCI is received in a first component carrier, the scheduled PDSCH or A-CSI is received in a second component carrier, and the resources for the PDSCH or A-CSI are received less than a threshold period of time after the scheduling DCI, then the UE 115 may be unable to determine a default beam, leading to transmission failure, increased latency, and degraded user experience among other disadvantages.

The techniques described herein may enable the UE 115 to select a default beam in cross-carrier scheduling in a unified TCI framework. For example, the UE 115 may receive control signaling (e.g., two DCIs for a unified TCI framework) on a first component carrier. The control signaling may indicate resources for a PDSCH or A-CSI on a different component carrier. The UE 115 may determine whether a PCI of the indicated or activated unified TCI state in an active BWP of the second component carrier matches a PCI for a serving cell of the second component carrier. If there is a match, then the UE 115 may apply the unified TCI state indicated or activated in the active BWP of the second component carrier for the scheduled PDSCH or A-CSI regardless of whether the threshold time period is satisfied. However, if the UE 115 determines that the PCIs do not match, and that the PDSCH or A-CSI is scheduled within the threshold time period, the UE 115 may select a default TCI state that has a lowest ID of all activated TCIs states in the active BWP of the second component carrier. In some cases, if the QCL-TypeD property for default beams in a slot for multiple component carriers in a band are different, the UE 115 may apply the default beam for the component carrier with lowest ID for the multiple component carriers in a band.

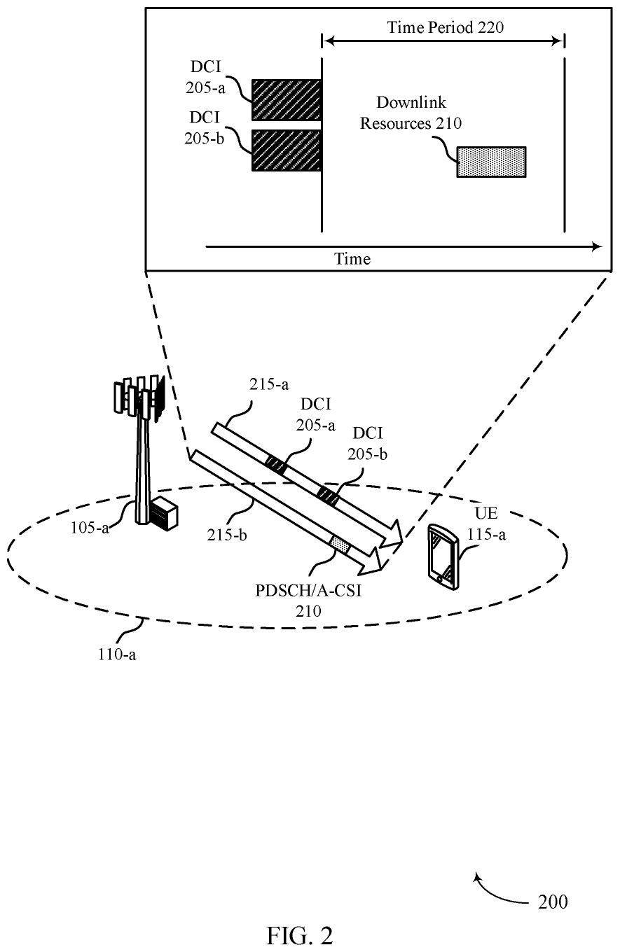

FIG. 2 illustrates an example of a wireless communications system 200 that supports cross-carrier scheduling in unified TCI frameworks in accordance with one or more aspects of the present disclosure. The wireless communications system 200 may implement, or be implemented by, aspects of the wireless communications system 100. For example, the wireless communications system 200 may include a UE 115-a and a network entity 105-a, which may be examples of corresponding devices described herein with respect to FIG. 1. The network entity 105-a may serve one or more UEs 115 within a coverage area 110-a.

In some examples of the wireless communications system 200, a network entity 105-a may schedule data signaling on downlink resources 210 (e.g., downlink signaling on a PDSCH or A-CSI signaling) via cross-carrier scheduling. The UE 115-a may receive the scheduling information via one or more DCIs 205. For example, the UE 115-a may receive a scheduling DCI 205-a on a first component carrier 215-a, where the DCI 205-a schedules downlink resources 210 (e.g., for a PDSCH or A-CSI) on a second component carrier 215-b. The UE 115-a may also support a unified TCI framework, in which the network entity 105-a may activate or indicate multiple unified TCI states for a component carrier 215. However, if the UE 115-a is scheduled with resources 210 for the PDSCH or A-CSI less than a threshold time period 220 after receiving the scheduling DCI 205-a, the UE 115-a may not be able to decode the DCI 205-a and determine the beam on which to receive the PDSCH or A-CSI and thus may choose a default beam for transmitting the PDSCH or A-CSI via the resources 210.

However, current techniques for determining a default beam may not support the case in which the PDSCH or A-CSI is scheduled prior to the threshold time period 220 in a unified TCI framework during cross-carrier scheduling. That is, if the UE 115-a receives the DCI 205-a on a first component carrier 215-a, where the DCI 205-a indicates a TCI state for a PDSCH or A-CSI via the downlink resources 210 on a second component carrier 215-b, and the resources 210 for the PDSCH or A-CSI are scheduled less than a threshold time period 220 after the DCI 205-a, then the UE 115-a may be unable to determine a default beam to use for reception of the PDSCH or A-CSI, leading to transmission failure, increased latency, and degraded user experience among other disadvantages.

In some implementations, the UE 115-a may select a default beam for reception of the PDSCH or A-CSI during cross-carrier scheduling in a unified TCI framework. For example, the UE 115-a may receive control signaling, including a DCI 205-a and DCI 205-b on a component carrier 215-a. The control signaling may indicate one or more TCI states or a resource grant for resources 210 (e.g., for receiving a PDSCH or A-CSI) on a different component carrier 215-b. For example, the control signaling may first indicate or activate a unified TCI state for the component carrier 215-b, and then indicate a resource grant for resources 210 for the component carrier 215-b. In such examples, the UE 115-a may determine whether a PCI of the indicated or activated TCI state in an active BWP of the second component carrier 215-b matches a PCI for a serving cell of the second component carrier 215-b. If the two PCIs match, then the UE 115-a may apply the TCI state indicated in the control signaling (e.g., the DCI 205-a and the DCI 205-b) for the granted resources 210, regardless of whether the threshold time period 220 is satisfied. For instance, in a unified TCI framework, the control signaling may include a scheduling DCI 205-a and a beam indicator DCI 205-b, and the UE 115-a may receive the downlink data on the PDSCH or the A-CSI, via the downlink resources 210, using the TCI state indicated in the TCI indicator DCI 205-b. However, if the UE 115-a determines that the PCIs do not match, and that the PDSCH or A-CSI is scheduled within the threshold time period 220, the UE 115-a may select a default TCI state (e.g., select a default beam) with the lowest ID of one or more activated TCI states in an active BWP of the second component carrier 215-b. Thus, the UE 115-a may receive the PDSCH or A-CSI via the selected default beam associated with the selected TCI state.

For example, if the network entity 105-a configures the UE 115-a with a control resource set (e.g., CORESET) associated with a search space set for cross-carrier scheduling, and if the UE 115-a receives the control signaling on the PDCCH carrying the scheduling DCI 205-a and the beam indicator DCI 205-b on component carrier 215-a, and receives the data signaling via the PDSCH or A-CSI (e.g., scheduled by the DCI 205-a and the DCI 205-b) on the component carrier 215-b, then the UE 115-a may determine whether a PCI of the activated TCI state in an active BWP of the second component carrier 215-b matches a PCI for a serving cell of the second component carrier 215-b.

In some examples, the UE 115-a may determine that the indicated unified TCI state for the scheduled component carrier 215-b is associated with the serving cell PCI of the scheduled component carrier 215-b (e.g., intra-cell cross-carrier scheduling). In such cases, the UE 115-a may apply the indicated unified TCI state for the scheduled component carrier 215 to receive the PDSCH or A-CSI irrespective of the time offset between the reception of the DCIs 205 and the corresponding PDSCH or A-CSI. For example, in such cases, the UE 115-a may use the TCI state indicated in the DCI 205-b for the data signaling via the PDSCH or the A-CSI. That is, the UE 115-a may apply the indicated TCI for the scheduled component carrier 215 to receive the PDSCH or A-CSI 210 irrespective of the time offset between the reception of the downlink DCIs 205 and the corresponding PDSCH or A-CSI 210, based on the PCIs matching.

In some other examples, the UE 115-a may determine that the indicated TCI state for the scheduled component carrier 215-b is associated with a PCI that is different from the serving cell PCI of the scheduled component carrier 215-b (e.g., inter-cell cross carrier scheduling). In such cases, the UE 115-a may select a default beam by applying the activated TCI state with the lowest ID applicable to the PDSCH or A-CSI in the active BWP of the scheduled component carrier 215-b. Thus, the UE 115-a may receive the PDSCH or A-CSI when the time offset between the reception of the downlink DCIs 205 and the corresponding PDSCH or A-CSI 210 is less than the threshold time period 220 using the selected default beam. Further, the UE 115-a may determine that QCL-TypeD properties for the default beams in a slot for different component carriers 215 in the same frequency band as the component carrier 215-a are different. In such cases, the UE 115-a may select (e.g., prioritize) the default beam for one component carrier 215 with lowest ID among multiple component carriers 215. That is, the UE 115-a may apply the default beam for the component carrier 215-a to all the component carriers 215 in a band. The UE 115-a may thus apply the activated TCI with the lowest ID associated with the PDSCH in the active BWP of the scheduled component carrier 215-b to receive the PDSCH or A-CSI.

In some cases, the UE 115-a may receive (e.g., via the DCI 205-a and the DCI 205-b) multiple (e.g., two) media access control (MAC) control elements (CEs) activating TCI states for the scheduled PDSCH or A-CSI. In such cases, one MAC-CE activating one or more TCI states may be a unified TCI activation MAC-CE, and the other MAC-CE activating one or more TCI states may be a non-unified TCI activation MAC-CE. For instance, the UE 115-a may receive control signaling indicating multiple TCI states, where a first quantity of TCI states correspond to a unified TCI framework and a second quantity of TCI states correspond to a non-unified TCI state. In such cases, the UE 115-a may select the TCI state with the lowest ID, which may be among TCIs activated by one of the MAC-CE. For example, the network entity 105-a may configure the UE 115-a with a set of TCI states. The various TCI states may include joint TCI states, pairs or subsets of TCI states, or the like, for a unified TCI framework. In such examples, the network entity 105-a may transmit (e.g., via one or more MAC-CEs) an indication that activates one or more of the configured TCI states. For example, a non-unified TCI framework MAC-CE may activate one or more TCI states (e.g., each TCI state associated with one channel). A unified TCI framework MAC-CE may activate one or a set of the TCI states. In some examples, the DCI 205-b may indicate one of the activated TCI states, or may indicate a set of the activated TCI states (e.g., may indicate a pair of TCI states for downlink signaling in the unified TCI framework), or may activate one or a set of TCI states. In such examples, if the PCIs do not match, and the downlink resources 210 occur prior to expiration of the time period 220 after receiving the one or more DCIs 205, the UE 115-a may select whichever activated TCI state has the lowest ID value.

In some implementations of the wireless communication system 200, if the PDCCH carrying the scheduling DCI 205 is received on one component carrier 215, and a PDSCH or A-CSI scheduled by that DCI 205 is on another component carrier 215, and if there is an indicated TCI in the active BWP of the scheduled component carrier 215, the UE 115-a may obtain its QCL assumption for the scheduled PDSCH or A-CSI from the indicated TCI in the active BWP of the scheduled cell.

In some implementations of the wireless communication system 200, the UE 115-a may select a default beam for a unified TCI framework during cross-carrier scheduling when the PCI of the indicated TCI state for component carrier 215-b and the PCI of the serving cell for component carrier 215-b match based on a QCL assumption. For example, if the PDCCH carrying the scheduling DCIs 205 is received on one component carrier 215-a, and a PDSCH or A-CSI scheduled by that DCI 205 is on another component carrier 215-b, and if there is an indicated TCI in the active BWP of the scheduled component carrier 215-b, then the UE 115-a may obtain a QCL assumption for the scheduled PDSCH or A-CSI from the indicated TCI in the active BWP of the scheduled cell. For example, if the indicated TCI in the active BWP of the scheduled component carrier 215-b is associated with a PCI different from a serving cell PCI of the scheduled component carrier 215-b, the UE 115-a may obtain its QCL assumption for the scheduled PDSCH or A-CSI from the indicated TCI in the active BWP of the scheduled component carrier 215-b.

Additionally, or alternatively, the UE 115-a may select a default beam in a unified TCI framework during cross-carrier scheduling when the PCI of the indicated TCI state for component carrier 215-b and the PCI of the serving cell for component carrier 215-b are different based on a QCL assumption from an activated TCI state associated with the lowest ID. For example, if the PDCCH carrying the scheduling DCIs 205 is received on one component carrier 215-a, and a PDSCH scheduled by the DCIs 205 is on another component carrier 215-b, and if the indicated TCI in the active BWP of the scheduled component carrier 215-b is associated with a PCI different from the serving cell PCI of the scheduled component carrier 215-b, and when the UE 115-a is configured with a cross-carrier scheduling default beam parameter (e.g., enableDefaultBeamForCCS), if the offset between the reception of the downlink DCI 205 and the corresponding PDSCH is less than the threshold time period 220 (e.g., where the time period 220 is defined by a higher layer parameter such as timeDurationForQCL), or if the downlink DCI 205 does not have the TCI field present, the UE 115-a may obtain its QCL assumption for the scheduled PDSCH from the activated TCI state with the lowest ID applicable to PDSCH in the active BWP of the scheduled component carrier 215-b.

In some cases, if the PDCCH carrying the scheduling DCI 205 is received on one component carrier 215, and a PDSCH scheduled by that DCI 205 is on another component carrier 215: 1) The predetermined threshold (e.g., timeDurationForQCL) may be determined based on the subcarrier spacing of the scheduled PDSCH. If μ_{PDCCH}<μ_{PDSCH}, an additional timing delay

$$d \frac{{2}^{{μ}_{PDSCH}}}{{2}^{{μ}_{PDCCH}}}$$

is added to the predetermined threshold (e.g., timeDurationForQCL), where d is a delay value, otherwise d is zero; 2) When the UE 115-a is configured with a cross-carrier scheduling default beam parameter (e.g., enableDefaultBeamForCCS) and is not indicated with a unified TCI state (e.g., a TCI configured as DLorJointTCIState) for the active BWP of the component carrier 215 with the scheduled PDSCH, if the offset between the reception of the DL DCI 205 and the corresponding PDSCH is less than the predetermined threshold (e.g., timeDurationForQCL), or if the DL DCI 205 does not have the TCI field present, the UE 115-a may obtain its QCL assumption for the scheduled PDSCH from the activated TCI state with the lowest ID applicable to PDSCH in the active BWP of the scheduled cell. 3) When the UE 115-a is configured with a cross-carrier scheduling default beam parameter (e.g., enableDefaultBeamForCCS) and is indicated with a unified TCI state (e.g., a TCI configured as DLorJointTCIState) for the active BWP of the component carrier 215 with the scheduled PDSCH, if the offset between the reception of the DL DCI 205 and the corresponding PDSCH is less than the predetermined threshold (e.g., timeDurationForQCL), or if the DL DCI 205 does not have the TCI field present, the UE 115-a may obtain its QCL assumption for the scheduled PDSCH based on the indicated TCI (e.g., the TCI configured as DLorJointTCIState) for the active BWP of the component carrier 215 with the scheduled PDSCH.

In some cases, the UE 115-a may select a default beam during cross-carrier scheduling in a unified TCI framework, where the A-CSI reporting or A-CSI reference signal (A-CSI-RS), corresponding to the triggering PDCCH, and the CSI-RS have the same numerology based on one or more conditions. For example, the UE 115-a may select a default beam based on determining if the scheduling offset between the last symbol of the PDCCH carrying the triggering DCI and the first symbol of the aperiodic CSI-RS resources in a CSI-RS resource set (e.g., NZP-CSI-RS-ResourceSet), configured without higher layer parameter (e.g., trs-Info) is: smaller than the UE 115 reported beam switching threshold (e.g., beamSwitchTiming) when the reported value is one of the values of {14, 28, 48}·2^{max(0, μ}^{_{CSIRS}}⁻³⁾ and a beam switch enable parameter (e.g., enableBeamSwitchTiming) is not provided; or is smaller than 48·2^{max(0, μ}^{_{CSIRS}}⁻³⁾ when the UE 115-a provides a beam switching threshold parameter (e.g., beamSwitchTiming-r16), the beam switch enable parameter (e.g., enableBeamSwitchTiming) is provided and the CSI-RS resource set (e.g., NZP-CSI-RS-ResourceSet) is configured with the higher layer parameter repetition set to off or configured without the higher layer parameter repetition; or is smaller than the UE 115-a reported threshold beamSwitchTiming-r16 when the beam switching threshold parameter (e.g., enableBeamSwitchTiming) is provided and the CSI-RS resource set (e.g., NZP-CSI-RS-ResourceSet) is configured with the higher layer parameter repetition set to on.

Alternatively, if there is an indicated TCI in the active BWP of the scheduled component carrier 215-b, and when receiving the aperiodic CSI-RS, the UE 115-a may apply the QCL assumption of the indicated TCI in the active BWP of the cell in which the CSI-RS is to be received.

In some other cases, the UE 115-a may select a default beam during cross-carrier scheduling, where the A-CSI reporting or A-CSI-RS, corresponding to the triggering PDCCH, and the CSI-RS have different numerologies based on one or more conditions. For example, the UE 115-a may select a default beam based on determining if the scheduling offset between the last symbol of the PDCCH carrying the triggering DCI and the first symbol of the aperiodic CSI-RS resources in a CSI-RS resource set (e.g., NZP-CSI-RS-ResourceSet) configured without a higher layer parameter (e.g., trs-Info) is: smaller than a beamSwitchTiming+d·2^{μ}^{_{CSIRS}}/2^{μ}^{_{PDCCH}} in CSI-RS symbols when the reported value is one of the values of {14, 28, 48}·2^{max(0, μ}^{_{CSIRS}}⁻³⁾ and the beam switching enable parameter (e.g., enableBeamSwitchTiming) is not provided; or is smaller than 48·2^{max(0, μ}^{_{CSIRS}}⁻³⁾+d·2^{μ}^{_{CSIRS}}/2^{μ}^{_{PDCCH}} in CSI-RS symbols when the UE provides a beam switching threshold parameter (e.g., beamSwitchTiming-r16) and the beam switching enable parameter (e.g., enableBeamSwitchTiming) is provided and the CSI-RS resource set (e.g., NZP-CSI-RS-ResourceSet) is configured with the higher layer parameter repetition set to off or configured without the higher layer parameter repetition; or is smaller than beamSwitchTiming-r16+d·2^{μ}^{_{CSIRS}}/2^{μ}^{_{PDCCH}} in CSI-RS symbols, when the beam switching enable parameter (e.g., enableBeamSwitchTiming) is provided and CSI-RS resource set (e.g., NZP-CSI-RS-ResourceSet) is configured with the higher layer parameter repetition set to ‘on’, where if the μ_{PDCCH}<μ_{CSIRS}, the beam switching timing delay d may be defined, else d is zero.

In some examples, the UE 115-a may determine if there are any other downlink signals with an indicated TCI state in the same symbols as the CSI-RS. Additionally, or alternatively, the UE 115-a may determine if there is an indicated TCI in the active BWP of the scheduled component carrier 215-a, and when receiving the aperiodic CSI-RS, the UE 115-a may apply the QCL assumption of the indicated TCI in the active BWP of the cell in which the CSI-RS is to be received.

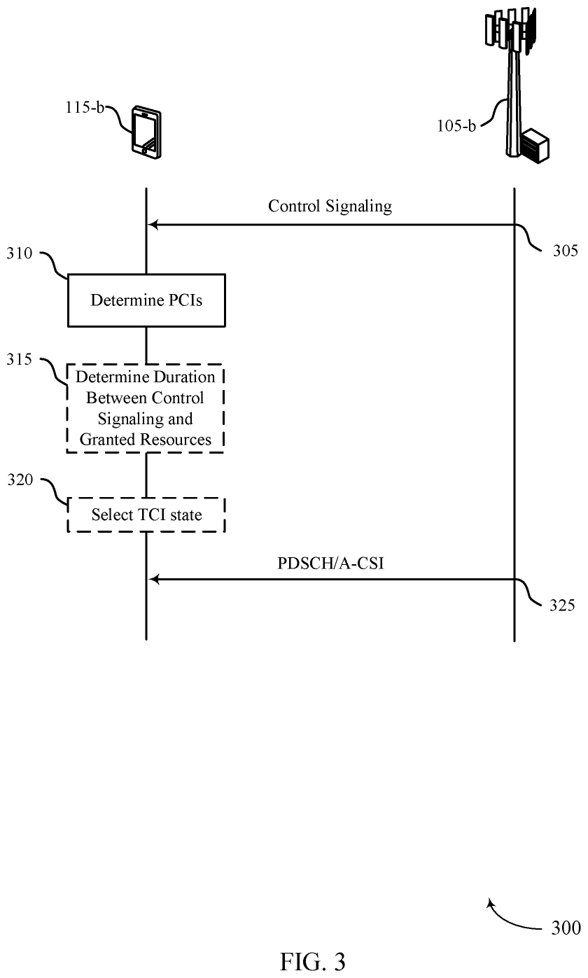

FIG. 3 illustrates an example of a process flow 300 that supports cross-carrier scheduling in unified TCI frameworks in accordance with one or more aspects of the present disclosure. The process flow 300 may implement, or be implemented, by aspects of the wireless communications system 100 and the wireless communications system 200. For example, the process flow 300 may include a UE 115-b and a network entity 105-b, which may be examples of corresponding devices, described herein with reference to FIGS. 1 and 2.

At 305, the UE 115-b may receive, and the network entity 105-a output, control signaling on a first component carrier. In some cases, the control signaling may indicate a first TCI state and a grant of resources for receiving a data transmission or an A-CSI on a second component carrier that is different from the first component carrier. For example, the first component carrier and the second component carrier may be examples of a component carrier 215-a and component carrier 215-b, as described herein with respect to FIG. 2. In some cases, the control signaling may support a unified TCI state configuration (e.g., unified TCI framework) and may include a first DCI message indicating the first TCI state, multiple TCI states, or both and a second DCI message indicating the granted resources.

Further, in some examples, the control signaling may include a threshold time period, which may be an example of a threshold time period 220 (e.g., timeDurationForQCL). Additionally, the control signaling may include a beam switch enable parameter (e.g., enableBeamSwitchTiming) enabling the UE 115-b to select a default TCI state for cross-carrier scheduling.

At 310, the UE 115-b may determine whether a first PCI associated with the first TCI state in an active BWP part of the second component carrier and a second PCI associated with the serving cell of the second component carrier are the same (e.g., inter-cell or intra-cell scenarios, as described in greater detail with reference to FIG. 3). If the UE 115-b determines the first PCI and the second PCI are the same, the UE 115-b may select a TCI state, regardless of whether the scheduled data transmission or A-CSI is scheduled after a threshold time period after the scheduling DCI, as described at 320. If the UE 115-b determines that the first PCI and the second PCI are different, the UE 115-b may determine whether the granted resources occur within the threshold time period, at 315.

At 315, the UE 115-b may determine that a duration between receiving the control signaling and the granted resources does not satisfy a threshold time period based on determining that the first PCI and the second PCI are different. For example, the UE 115-b may determine that the granted resources for the data transmission (e.g., PDSCH) or A-CSI were received less than a threshold time period after receiving the control signaling. In such cases, the UE 115-b may identify the multiple TCI states activated for the second component carrier, where each TCI state corresponds to an index value, which may be an example of a TCI ID described herein with reference to FIG. 2.

At 320, the UE 115-b may select the first TCI state. For example, the UE 115-b may select the first TCI state indicated in the control signaling regardless of the time threshold based on determining that the first PCI and the second PCI match. In some other examples, the UE 115-b may select a TCI state with the lowest index value (e.g., lowest ID) from the multiple TCI states indicated in the control signaling based on the first PCI and the second PCI being different. That is, if the UE 115-b determines at step 310 that the first PCI and the second PCI are the same, the UE 115-b may select the first TCI state indicated in the control signaling.

In some examples, if the UE 115-b determines at step 310 that the first PCI and the second PCI are different, the UE 115-b may select the TCI state with the lowest ID of the multiple TCI states. In some cases, if the UE 115-b determines that the first PCI and the second PCI are different, the UE 115-b may apply the selected TCI state with the lowest ID to multiple component carriers of a carrier aggregation configuration, which may include the first component carrier and the second component carrier.

At 325, the UE 115-b may receive, and the network entity 105-b transmit, via the first TCI state on the second component carrier, the data transmission or the A-CSI.

The network entity 105-b may perform similar operations. For example, upon scheduling the PDSCH or A-CSI (e.g., via the control signaling at 305), the network entity 105-b may determine whether the scheduled PDSCH or A-CSI is scheduled within a threshold time period of the control signaling. Based thereon, and based on whether the PCIs match, the network entity 105-b may select a transmit beam on which to transmit the data signaling or A-CSI at 325 such that the selected transmit beam aligns with the default TCI state selected by the UE 115-b at 320 (e.g., based on whether the PCIs match and whether the PDSCH or A-CSI is scheduled within the threshold time period).

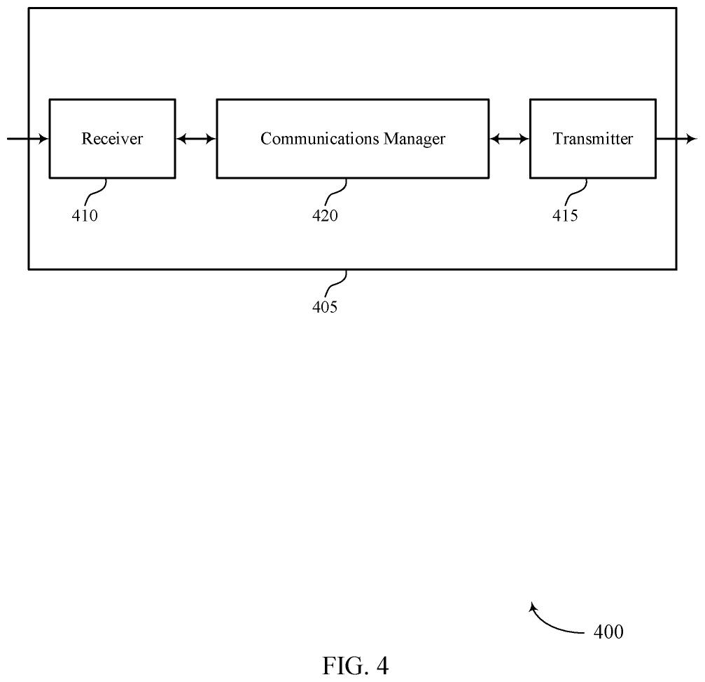

FIG. 4 shows a block diagram 400 of a device 405 that supports cross-carrier scheduling in unified TCI frameworks in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to cross-carrier scheduling in unified TCI frameworks). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to cross-carrier scheduling in unified TCI frameworks). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of cross-carrier scheduling in unified TCI frameworks as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 may be configured as or otherwise support a means for receiving control signaling on a first component carrier, the control signaling including an indication of a first TCI state and a grant of resources for receiving a data transmission or an A-CSI transmission on a second component carrier that is different from the first component carrier. The communications manager 420 may be configured as or otherwise support a means for determining whether a first PCI associated with the first TCI state in an active BWP of the second component carrier and a second PCI associated with a serving cell of the second component carrier are the same. The communications manager 420 may be configured as or otherwise support a means for receiving, via the first TCI state based on the determining, the data transmission or the A-CSI transmission via the second component carrier according to the grant of resources.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for more efficient utilization of communication resources.

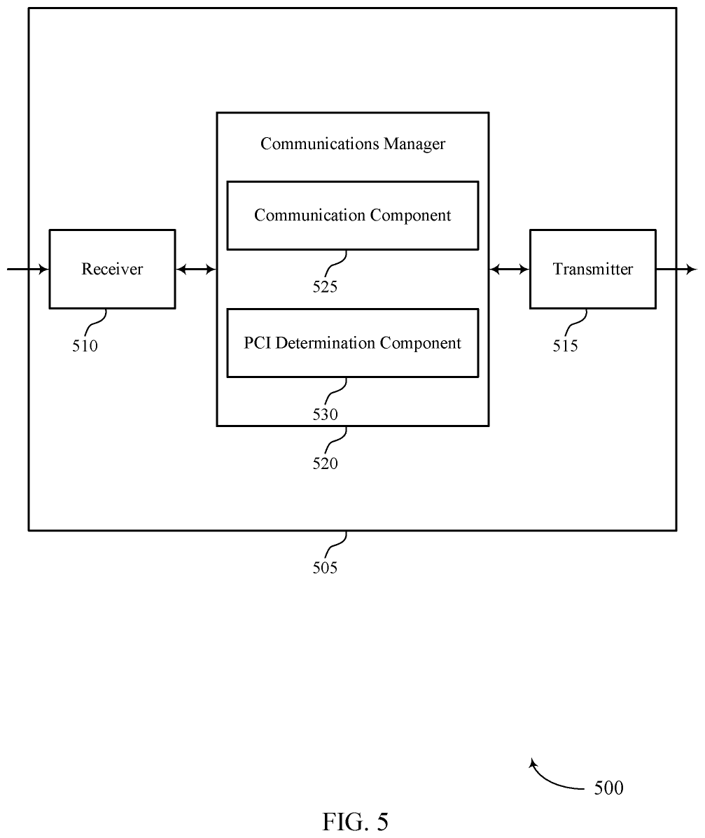

FIG. 5 shows a block diagram 500 of a device 505 that supports cross-carrier scheduling in unified TCI frameworks in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to cross-carrier scheduling in unified TCI frameworks). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to cross-carrier scheduling in unified TCI frameworks). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of cross-carrier scheduling in unified TCI frameworks as described herein. For example, the communications manager 520 may include a communication component 525 a PCI determination component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The communication component 525 may be configured as or otherwise support a means for receiving control signaling on a first component carrier, the control signaling including an indication of a first TCI state and a grant of resources for receiving a data transmission or an A-CSI transmission on a second component carrier that is different from the first component carrier. The PCI determination component 530 may be configured as or otherwise support a means for determining whether a first PCI associated with the first TCI state in an active BWP of the second component carrier and a second PCI associated with a serving cell of the second component carrier are the same. The communication component 525 may be configured as or otherwise support a means for receiving, via the first TCI state based on the determining, the data transmission or the A-CSI transmission via the second component carrier according to the grant of resources.

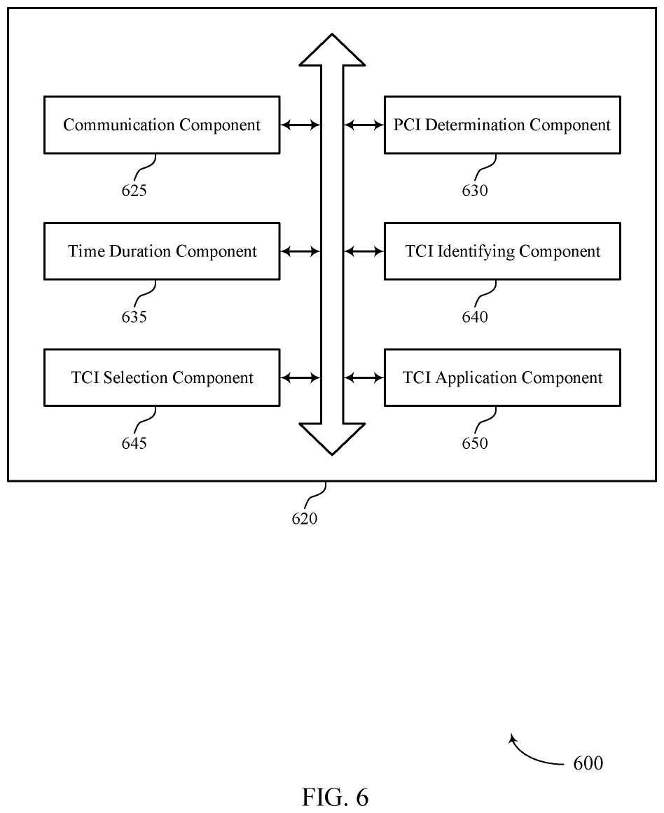

FIG. 6 shows a block diagram 600 of a communications manager 620 that supports cross-carrier scheduling in unified TCI frameworks in accordance with one or more aspects of the present disclosure. The communications manager 620 may be an example of aspects of a communications manager 420, a communications manager 520, or both, as described herein. The communications manager 620, or various components thereof, may be an example of means for performing various aspects of cross-carrier scheduling in unified TCI frameworks as described herein. For example, the communications manager 620 may include a communication component 625, a PCI determination component 630, a time duration component 635, a TCI identifying component 640, a TCI selection component 645, a TCI application component 650, or any combination thereof. Each of these components may communicate, directly or indirectly, with one another (e.g., via one or more buses).

The communications manager 620 may support wireless communications at a UE in accordance with examples as disclosed herein. The communication component 625 may be configured as or otherwise support a means for receiving control signaling on a first component carrier, the control signaling including an indication of a first TCI state and a grant of resources for receiving a data transmission or an A-CSI transmission on a second component carrier that is different from the first component carrier. The PCI determination component 630 may be configured as or otherwise support a means for determining whether a first PCI associated with the first TCI state in an active BWP of the second component carrier and a second PCI associated with a serving cell of the second component carrier are the same. In some examples, the communication component 625 may be configured as or otherwise support a means for receiving, via the first TCI state based on the determining, the data transmission or the A-CSI transmission via the second component carrier according to the grant of resources.

In some examples, the time duration component 635 may be configured as or otherwise support a means for determining that a duration of time between receiving the control signaling and the granted resources does not satisfy a threshold time period, where the first PCI and the second PCI are not the same. In some examples, the TCI identifying component 640 may be configured as or otherwise support a means for identifying a set of multiple TCI states including the first TCI state activated for the second component carrier, each of the set of multiple TCI states corresponding to a respective index value of a set of multiple index values. In some examples, the TCI selection component 645 may be configured as or otherwise support a means for selecting the first TCI state from the set of multiple TCI states activated for the second component carrier based on the first TCI state corresponding to a lowest index value of the set of multiple index values and the duration of time not satisfying the threshold time period.

In some examples, the communication component 625 may be configured as or otherwise support a means for receiving, in the control signaling, an indication of the set of multiple TCI states.

In some examples, the TCI application component 650 may be configured as or otherwise support a means for applying the first TCI state to a set of multiple component carriers of a carrier aggregation configuration including the first component carrier and the second component carrier based on the first TCI state corresponding to the lowest index value of the set of multiple index values.

In some examples, the communication component 625 may be configured as or otherwise support a means for receiving control signaling including an indication of the threshold time period.

In some examples, the communication component 625 may be configured as or otherwise support a means for receiving control signaling enabling the UE to select a default TCI state for cross-carrier scheduling, where selecting the first TCI state is based on receiving the control signaling enabling the UE to select the default TCI state for cross-carrier scheduling.

In some examples, the TCI selection component 645 may be configured as or otherwise support a means for selecting the first TCI state based on the determining, where the first PCI and the second PCI are the same, and where receiving the data transmission or the A-CSI transmission is based on the selecting.

In some examples, to support receiving the control signaling, the communication component 625 may be configured as or otherwise support a means for receiving a first DCI message including the indication of the first TCI state. In some examples, to support receiving the control signaling, the communication component 625 may be configured as or otherwise support a means for receiving a second DCI message including the grant of resources, where the first DCI message and the second DCI message support a unified TCI state configuration.

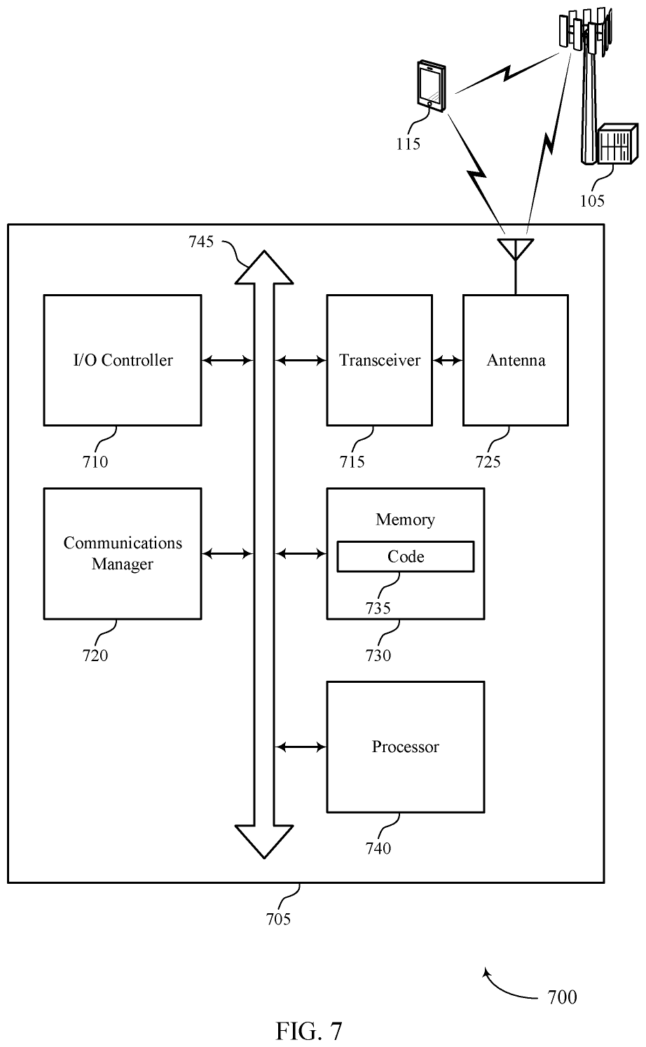

FIG. 7 shows a diagram of a system 700 including a device 705 that supports cross-carrier scheduling in unified TCI frameworks in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting cross-carrier scheduling in unified TCI frameworks). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for receiving control signaling on a first component carrier, the control signaling including an indication of a first TCI state and a grant of resources for receiving a data transmission or an A-CSI transmission on a second component carrier that is different from the first component carrier. The communications manager 720 may be configured as or otherwise support a means for determining whether a first PCI associated with the first TCI state in an active BWP of the second component carrier and a second PCI associated with a serving cell of the second component carrier are the same. The communications manager 720 may be configured as or otherwise support a means for receiving, via the first TCI state based on the determining, the data transmission or the A-CSI transmission via the second component carrier according to the grant of resources.

By including or configuring the communications manager 720 in accordance with examples as described herein, the device 705 may support techniques for improved communication reliability and reduced latency.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of cross-carrier scheduling in unified TCI frameworks as described herein, or the processor 740 and the memory 730 may be otherwise configured to perform or support such operations.

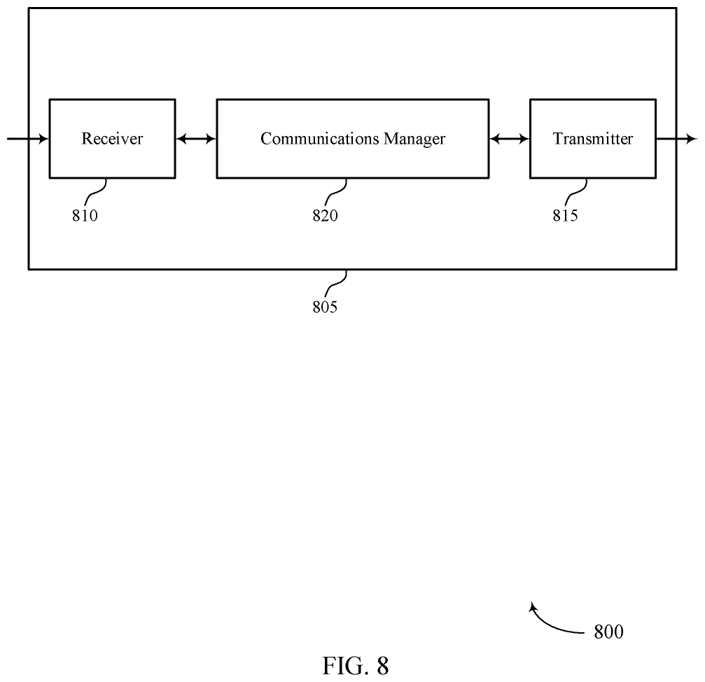

FIG. 8 shows a block diagram 800 of a device 805 that supports cross-carrier scheduling in unified TCI frameworks in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of cross-carrier scheduling in unified TCI frameworks as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a network entity in accordance with examples as disclosed herein. For example, the communications manager 820 may be configured as or otherwise support a means for outputting control signaling on a first component carrier, the control signaling including an indication of a first TCI state and a grant of resources for outputting a data transmission or an A-CSI transmission on a second component carrier that is different from the first component carrier. The communications manager 820 may be configured as or otherwise support a means for determining whether a first PCI associated with the first TCI state in an active BWP of the second component carrier and a second PCI associated with a serving cell of the second component carrier are the same. The communications manager 820 may be configured as or otherwise support a means for outputting, via a first beam associated with a first TCI state based on the determining, the data transmission or the A-CSI transmission via the second component carrier according to the grant of resources.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for more efficient utilization of communication resources.

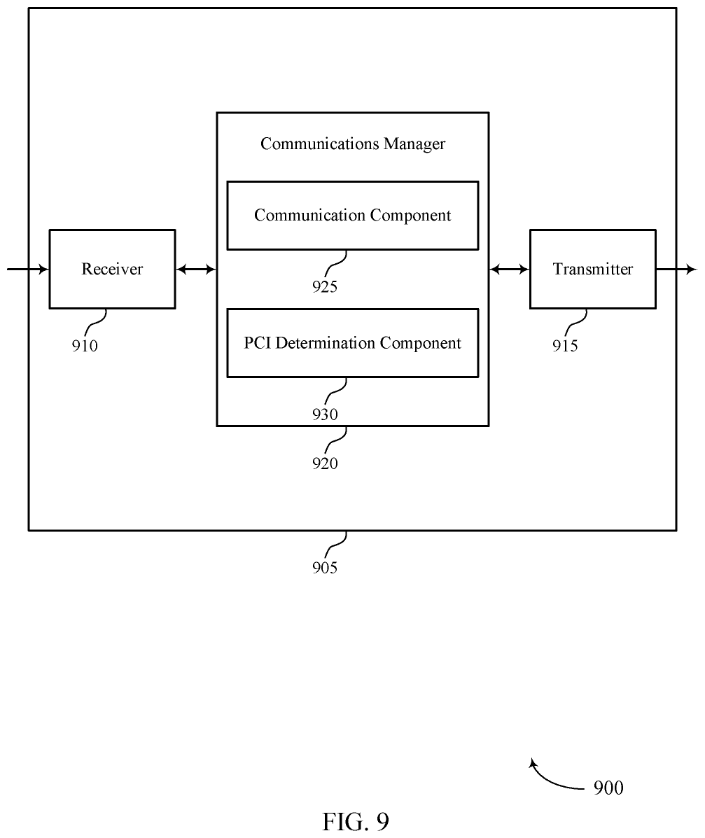

FIG. 9 shows a block diagram 900 of a device 905 that supports cross-carrier scheduling in unified TCI frameworks in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of cross-carrier scheduling in unified TCI frameworks as described herein. For example, the communications manager 920 may include a communication component 925 a PCI determination component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. The communication component 925 may be configured as or otherwise support a means for outputting control signaling on a first component carrier, the control signaling including an indication of a first TCI state and a grant of resources for outputting a data transmission or an A-CSI transmission on a second component carrier that is different from the first component carrier. The PCI determination component 930 may be configured as or otherwise support a means for determining whether a first PCI associated with the first TCI state in an active BWP of the second component carrier and a second PCI associated with a serving cell of the second component carrier are the same. The communication component 925 may be configured as or otherwise support a means for outputting, via a first beam associated with a first TCI state based on the determining, the data transmission or the A-CSI transmission via the second component carrier according to the grant of resources.

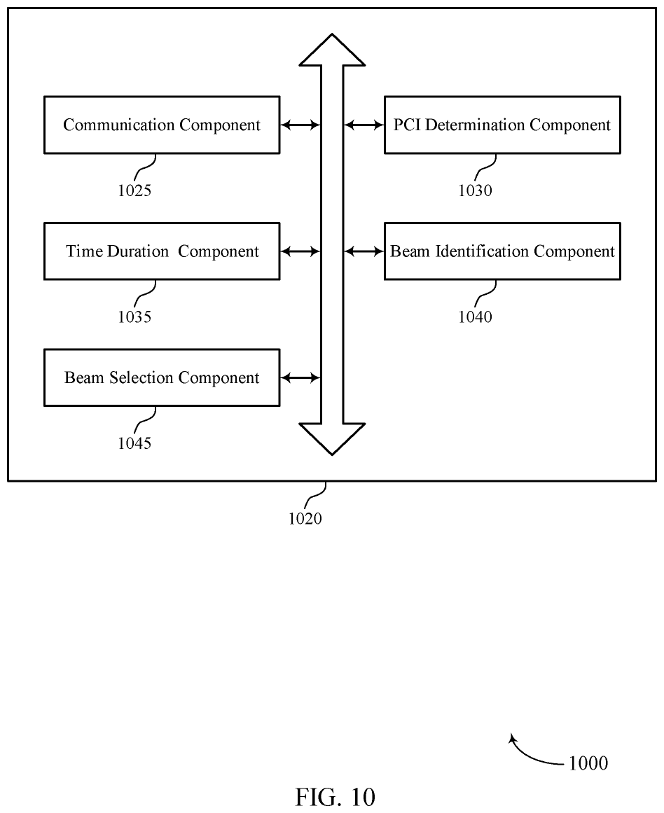

FIG. 10 shows a block diagram 1000 of a communications manager 1020 that supports cross-carrier scheduling in unified TCI frameworks in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of cross-carrier scheduling in unified TCI frameworks as described herein. For example, the communications manager 1020 may include a communication component 1025, a PCI determination component 1030, a time duration component 1035, a beam identification component 1040, a beam selection component 1045, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a network entity in accordance with examples as disclosed herein. The communication component 1025 may be configured as or otherwise support a means for outputting control signaling on a first component carrier, the control signaling including an indication of a first TCI state and a grant of resources for outputting a data transmission or an A-CSI transmission on a second component carrier that is different from the first component carrier. The PCI determination component 1030 may be configured as or otherwise support a means for determining whether a first PCI associated with the first TCI state in an active BWP of the second component carrier and a second PCI associated with a serving cell of the second component carrier are the same. In some examples, the communication component 1025 may be configured as or otherwise support a means for outputting, via a first beam associated with a first TCI state based on the determining, the data transmission or the A-CSI transmission via the second component carrier according to the grant of resources.

In some examples, the time duration component 1035 may be configured as or otherwise support a means for determining that a duration of time between outputting the control signaling and the granted resources does not satisfy a threshold time period, where the first PCI and the second PCI are not the same. In some examples, the beam identification component 1040 may be configured as or otherwise support a means for identifying a set of multiple beams associated with a set of multiple TCI states including the first TCI state activated for the second component carrier, each of the set of multiple TCI states corresponding to a respective index value of a set of multiple index values. In some examples, the beam selection component 1045 may be configured as or otherwise support a means for selecting the first beam associated with the first TCI state from the set of multiple TCI states activated for the second component carrier based on the first TCI state corresponding to a lowest index value of the set of multiple index values and the duration of time not satisfying the threshold time period.

In some examples, the communication component 1025 may be configured as or otherwise support a means for outputting, in the control signaling, an indication of the set of multiple TCI states.

In some examples, the first beam associated with the first TCI state to a set of multiple component carriers of a carrier aggregation configuration including the first component carrier and the second component carrier based on the first TCI state corresponding to the lowest index value of the set of multiple index values.

In some examples, the communication component 1025 may be configured as or otherwise support a means for outputting control signaling including an indication of the threshold time period.

In some examples, the communication component 1025 may be configured as or otherwise support a means for outputting control signaling enabling a UE to select a default TCI state for cross-carrier scheduling, where selecting the first TCI state is based on outputting the control signaling enabling the UE to select the default TCI state for cross-carrier scheduling.

In some examples, the beam selection component 1045 may be configured as or otherwise support a means for selecting the first beam associated with the first TCI state based on the determining, where the first PCI and the second PCI are the same, and where the outputting the data transmission or the A-CSI transmission via the first beam is based on the selecting.

In some examples, to support outputting the control signaling, the communication component 1025 may be configured as or otherwise support a means for outputting a first DCI message including the indication of the first TCI state. In some examples, to support outputting the control signaling, the communication component 1025 may be configured as or otherwise support a means for outputting a second DCI message including the grant of resources, where the first DCI message and the second DCI message support a unified TCI state configuration.

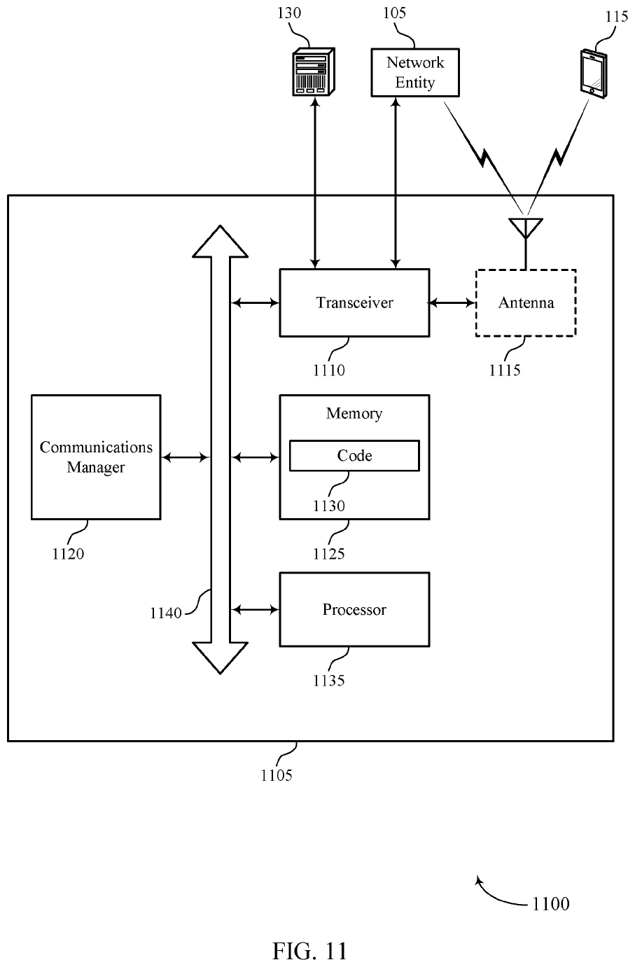

FIG. 11 shows a diagram of a system 1100 including a device 1105 that supports cross-carrier scheduling in unified TCI frameworks in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting cross-carrier scheduling in unified TCI frameworks). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a network entity in accordance with examples as disclosed herein. For example, the communications manager 1120 may be configured as or otherwise support a means for outputting control signaling on a first component carrier, the control signaling including an indication of a first TCI state and a grant of resources for outputting a data transmission or an A-CSI transmission on a second component carrier that is different from the first component carrier. The communications manager 1120 may be configured as or otherwise support a means for determining whether a first PCI associated with the first TCI state in an active BWP of the second component carrier and a second PCI associated with a serving cell of the second component carrier are the same. The communications manager 1120 may be configured as or otherwise support a means for outputting, via a first beam associated with a first TCI state based on the determining, the data transmission or the A-CSI transmission via the second component carrier according to the grant of resources.

By including or configuring the communications manager 1120 in accordance with examples as described herein, the device 1105 may support techniques for improved communication reliability and reduced latency.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of cross-carrier scheduling in unified TCI frameworks as described herein, or the processor 1135 and the memory 1125 may be otherwise configured to perform or support such operations.

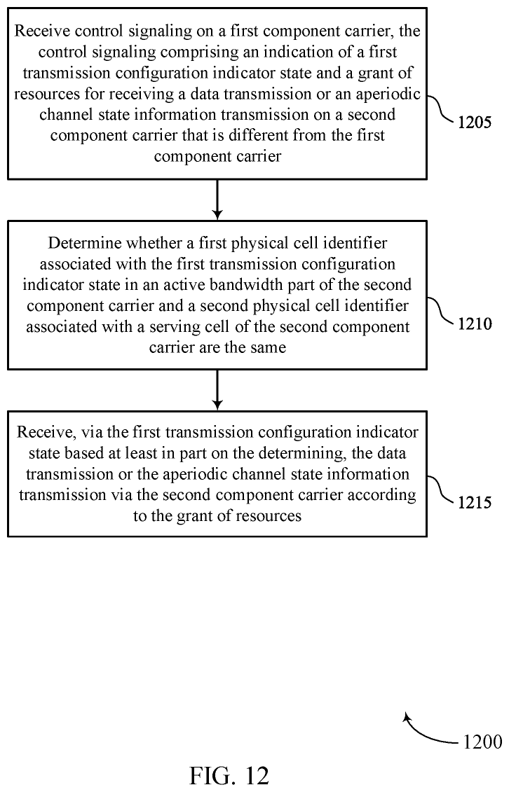

FIG. 12 shows a flowchart illustrating a method 1200 that supports cross-carrier scheduling in unified TCI frameworks in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving control signaling on a first component carrier, the control signaling including an indication of a first TCI state and a grant of resources for receiving a data transmission or an A-CSI transmission on a second component carrier that is different from the first component carrier. The operations of 1205 may be performed in accordance with examples as disclosed herein. In some examples, aspects of the operations of 1205 may be performed by a communication component 625 as described with reference to FIG. 6.

At 1210, the method may include determining whether a first PCI associated with the first TCI state in an active BWP of the second component carrier and a second PCI associated with a serving cell of the second component carrier are the same. The operations of 1210 may be performed in accordance with examples as disclosed herein. In some examples, aspects of the operations of 1210 may be performed by a PCI determination component 630 as described with reference to FIG. 6.

At 1215, the method may include receiving, via the first TCI state based on the determining, the data transmission or the A-CSI transmission via the second component carrier according to the grant of resources. The operations of 1215 may be performed in accordance with examples as disclosed herein. In some examples, aspects of the operations of 1215 may be performed by a communication component 625 as described with reference to FIG. 6.

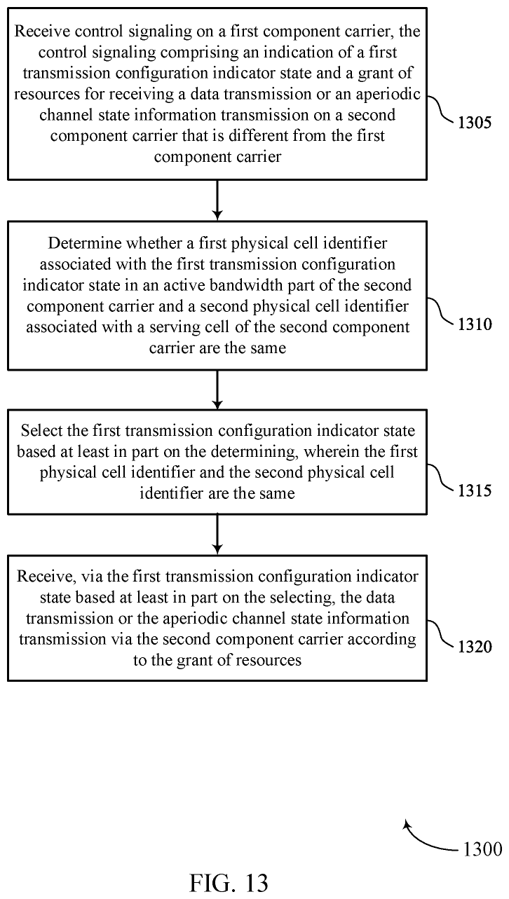

FIG. 13 shows a flowchart illustrating a method 1300 that supports cross-carrier scheduling in unified TCI frameworks in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving control signaling on a first component carrier, the control signaling including an indication of a first TCI state and a grant of resources for receiving a data transmission or an A-CSI transmission on a second component carrier that is different from the first component carrier. The operations of 1305 may be performed in accordance with examples as disclosed herein. In some examples, aspects of the operations of 1305 may be performed by a communication component 625 as described with reference to FIG. 6.

At 1310, the method may include determining whether a first PCI associated with the first TCI state in an active BWP of the second component carrier and a second PCI associated with a serving cell of the second component carrier are the same. The operations of 1310 may be performed in accordance with examples as disclosed herein. In some examples, aspects of the operations of 1310 may be performed by a PCI determination component 630 as described with reference to FIG. 6.

At 1315, the method may include selecting the first TCI state based on the determining, where the first PCI and the second PCI are the same. The operations of 1315 may be performed in accordance with examples as disclosed herein. In some examples, aspects of the operations of 1315 may be performed by a TCI selection component 645 as described with reference to FIG. 6.

At 1320, the method may include receiving, via the first TCI state based on the selecting, the data transmission or the A-CSI transmission via the second component carrier according to the grant of resources. The operations of 1320 may be performed in accordance with examples as disclosed herein. In some examples, aspects of the operations of 1320 may be performed by a communication component 625 as described with reference to FIG. 6.

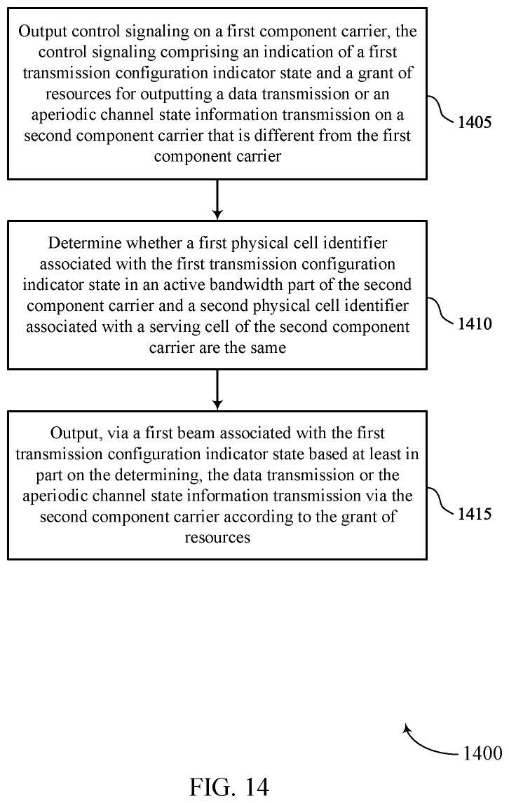

FIG. 14 shows a flowchart illustrating a method 1400 that supports cross-carrier scheduling in unified TCI frameworks in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include outputting control signaling on a first component carrier, the control signaling including an indication of a first TCI state and a grant of resources for outputting a data transmission or an A-CSI transmission on a second component carrier that is different from the first component carrier. The operations of 1405 may be performed in accordance with examples as disclosed herein. In some examples, aspects of the operations of 1405 may be performed by a communication component 1025 as described with reference to FIG. 10.

At 1410, the method may include determining whether a first PCI associated with the first TCI state in an active BWP of the second component carrier and a second PCI associated with a serving cell of the second component carrier are the same. The operations of 1410 may be performed in accordance with examples as disclosed herein. In some examples, aspects of the operations of 1410 may be performed by a PCI determination component 1030 as described with reference to FIG. 10.

At 1415, the method may include outputting, via a first beam associated with the first TCI state based on the determining, the data transmission or the A-CSI transmission via the second component carrier according to the grant of resources. The operations of 1415 may be performed in accordance with examples as disclosed herein. In some examples, aspects of the operations of 1415 may be performed by a communication component 1025 as described with reference to FIG. 10.

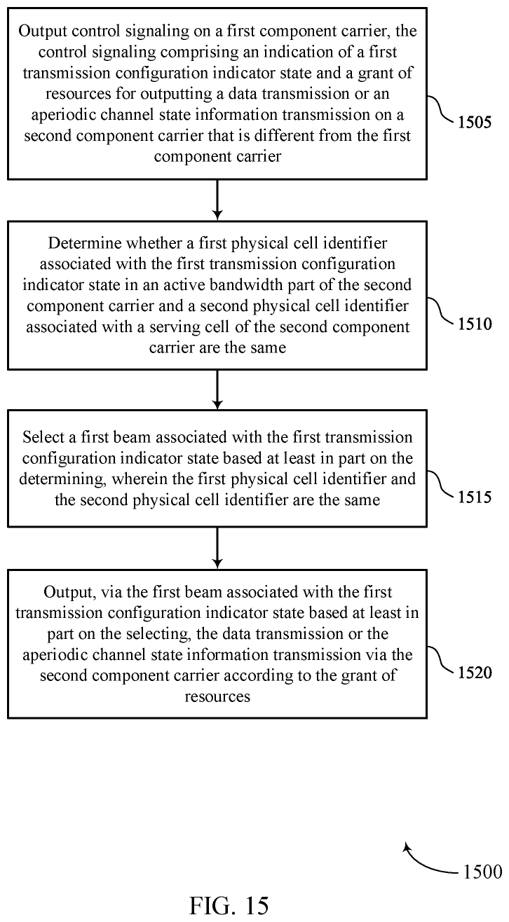

FIG. 15 shows a flowchart illustrating a method 1500 that supports cross-carrier scheduling in unified TCI frameworks in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting control signaling on a first component carrier, the control signaling including an indication of a first TCI state and a grant of resources for outputting a data transmission or an A-CSI transmission on a second component carrier that is different from the first component carrier. The operations of 1505 may be performed in accordance with examples as disclosed herein. In some examples, aspects of the operations of 1505 may be performed by a communication component 1025 as described with reference to FIG. 10.

At 1510, the method may include determining whether a first PCI associated with the first TCI state in an active BWP of the second component carrier and a second PCI associated with a serving cell of the second component carrier are the same. The operations of 1510 may be performed in accordance with examples as disclosed herein. In some examples, aspects of the operations of 1510 may be performed by a PCI determination component 1030 as described with reference to FIG. 10.

At 1515, the method may include selecting a first beam associated with the first TCI state based on the determining, where the first PCI and the second PCI are the same. The operations of 1515 may be performed in accordance with examples as disclosed herein. In some examples, aspects of the operations of 1515 may be performed by a beam selection component 1045 as described with reference to FIG. 10.

At 1520, the method may include outputting, via the first beam associated with the first TCI state based on the selecting, the data transmission or the A-CSI transmission via the second component carrier according to the grant of resources. The operations of 1520 may be performed in accordance with examples as disclosed herein. In some examples, aspects of the operations of 1520 may be performed by a communication component 1025 as described with reference to FIG. 10.

The following provides an overview of aspects of the present disclosure:

Aspect 1: A method for wireless communications at a UE, including: receiving control signaling on a first component carrier, the control signaling including an indication of a first TCI state and a grant of resources for receiving a data transmission or an A-CSI transmission on a second component carrier that is different from the first component carrier; determining whether a first PCI associated with the first TCI state in an active BWP of the second component carrier and a second PCI associated with a serving cell of the second component carrier are the same; and receiving, via the first TCI state based at least in part on the determining, the data transmission or the A-CSI transmission via the second component carrier according to the grant of resources.

Aspect 2: The method of aspect 1, further including: determining that a duration of time between receiving the control signaling and the granted resources does not satisfy a threshold time period, wherein the first PCI and the second PCI are not the same; identifying a plurality of TCI states including the first TCI state activated for the second component carrier, each of the plurality of TCI states corresponding to a respective index value of a plurality of index values; and selecting the first TCI state from the plurality of TCI states activated for the second component carrier based at least in part on the first TCI state corresponding to a lowest index value of the plurality of index values and the duration of time not satisfying the threshold time period.

Aspect 3: The method of aspect 2, further including: receiving, in the control signaling, an indication of the plurality of TCI states.

Aspect 4: The method of any of aspects 2 through 3, further including: applying the first TCI state to a plurality of component carriers of a carrier aggregation configuration including the first component carrier and the second component carrier based at least in part on the first TCI state corresponding to the lowest index value of the plurality of index values.

Aspect 5: The method of any of aspects 2 through 4, further including: receiving control signaling including an indication of the threshold time period.

Aspect 6: The method of any of aspects 2 through 5, further including: receiving control signaling enabling the UE to select a default TCI state for cross-carrier scheduling, wherein selecting the first TCI state is based at least in part on receiving the control signaling enabling the UE to select the default TCI state for cross-carrier scheduling.

Aspect 7: The method of aspect 1, further including: selecting the first TCI state based at least in part on the determining, wherein the first PCI and the second PCI are the same, and wherein receiving the data transmission or the A-CSI transmission is based at least in part on the selecting.

Aspect 8: The method of aspect 7, wherein receiving the control signaling includes: receiving a first DCI message including the indication of the first TCI state; and receiving a second DCI message including the grant of resources, wherein the first DCI message and the second DCI message support a unified TCI state configuration.

Aspect 9: A method for wireless communications at a network entity, including: outputting control signaling on a first component carrier, the control signaling including an indication of a first TCI state and a grant of resources for outputting a data transmission or an A-CSI transmission on a second component carrier that is different from the first component carrier; determining whether a first PCI associated with the first TCI state in an active BWP of the second component carrier and a second PCI associated with a serving cell of the second component carrier are the same; and outputting, via a first beam associated with the first TCI state based at least in part on the determining, the data transmission or the A-CSI transmission via the second component carrier according to the grant of resources.

Aspect 10: The method of aspect 9, further including: determining that a duration of time between outputting the control signaling and the granted resources does not satisfy a threshold time period, wherein the first PCI and the second PCI are not the same; identifying a plurality of beams associated with a plurality of TCI states including the first TCI state activated for the second component carrier, each of the plurality of TCI states corresponding to a respective index value of a plurality of index values; and selecting the first beam associated with the first TCI state from the plurality of TCI states activated for the second component carrier based at least in part on the first TCI state corresponding to a lowest index value of the plurality of index values and the duration of time not satisfying the threshold time period.

Aspect 11: The method of aspect 10, further including: outputting, in the control signaling, an indication of the plurality of TCI states.

Aspect 12: The method of any of aspects 10 through 11, wherein the first beam associated with the first configuration indicator state to a plurality of component carriers of a carrier aggregation configuration including the first component carrier and the second component carrier based at least in part on the first TCI state corresponding to the lowest index value of the plurality of index values.

Aspect 13: The method of any of aspects 10 through 12, further including: outputting control signaling including an indication of the threshold time period.

Aspect 14: The method of any of aspects 10 through 13, further including: outputting control signaling enabling a UE to select a default TCI state for cross-carrier scheduling, wherein selecting the first TCI state is based at least in part on outputting the control signaling enabling the UE to select the default TCI state for cross-carrier scheduling.

Aspect 15: The method of aspect 9, further including: selecting the first beam associated with the first TCI state based at least in part on the determining, wherein the first PCI and the second PCI are the same, and wherein the outputting the data transmission or the A-CSI transmission via the first beam is based at least in part on the selecting.

Aspect 16: The method of aspect 15, wherein outputting the control signaling includes: outputting a first DCI message including the indication of the first TCI state; outputting a second DCI message including the grant of resources, wherein the first DCI message and the second DCI message support a unified TCI state configuration.

Aspect 17: An apparatus for wireless communications at a UE, including a processor; memory coupled with the processor; and instructions stored in the memory and executable by the processor to cause the apparatus to perform a method of any of aspects 1 through 8.

Aspect 18: An apparatus for wireless communications at a UE, including at least one means for performing a method of any of aspects 1 through 8.

Aspect 19: A non-transitory computer-readable medium storing code for wireless communications at a UE, the code including instructions executable by a processor to perform a method of any of aspects 1 through 8.

Aspect 20: An apparatus for wireless communications at a network entity, including a processor; memory coupled with the processor; and instructions stored in the memory and executable by the processor to cause the apparatus to perform a method of any of aspects 9 through 16.

Aspect 21: An apparatus for wireless communications at a network entity, including at least one means for performing a method of any of aspects 9 through 16.

Aspect 22: A non-transitory computer-readable medium storing code for wireless communications at a network entity, the code including instructions executable by a processor to perform a method of any of aspects 9 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” may include calculating, computing, processing, deriving, investigating, looking up (such as via looking up in a table, a database or another data structure), ascertaining and the like. Also, “determining” may include receiving (e.g., receiving information), accessing (e.g., accessing data stored in memory) and the like. Also, “determining” may include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive control signaling on a first component carrier, the control signaling comprising an indication of a first transmission configuration indicator state and a grant of resources for receiving a data transmission or an aperiodic channel state information transmission on a second component carrier that is different from the first component carrier;
determine whether a first physical cell identifier associated with the first transmission configuration indicator state in an active bandwidth part of the second component carrier and a second physical cell identifier associated with a serving cell of the second component carrier are the same; and
receive, via the first transmission configuration indicator state based at least in part on the determining, the data transmission or the aperiodic channel state information transmission via the second component carrier according to the grant of resources.

2. The apparatus of claim 1, wherein the instructions are further executable by the processor to cause the apparatus to:
determine that a duration of time between receiving the control signaling and the granted resources does not satisfy a threshold time period, wherein the first physical cell identifier and the second physical cell identifier are not the same;
identify a plurality of transmission configuration indicator states comprising the first transmission configuration indicator state activated for the second component carrier, each of the plurality of transmission configuration indicator states corresponding to a respective index value of a plurality of index values; and
select the first transmission configuration indicator state from the plurality of transmission configuration indicator states activated for the second component carrier based at least in part on the first transmission configuration indicator state corresponding to a lowest index value of the plurality of index values and the duration of time not satisfying the threshold time period.

3. The apparatus of claim 2, wherein the instructions are further executable by the processor to cause the apparatus to:
receive, in the control signaling, an indication of the plurality of transmission configuration indicator states.

4. The apparatus of claim 2, wherein the instructions are further executable by the processor to cause the apparatus to:
apply the first transmission configuration indicator state to a plurality of component carriers of a carrier aggregation configuration comprising the first component carrier and the second component carrier based at least in part on the first transmission configuration indicator state corresponding to the lowest index value of the plurality of index values.

5. The apparatus of claim 2, wherein the instructions are further executable by the processor to cause the apparatus to:
receive control signaling comprising an indication of the threshold time period.

6. The apparatus of claim 2, wherein the instructions are further executable by the processor to cause the apparatus to:
receive control signaling enabling the UE to select a default transmission configuration indicator state for cross-carrier scheduling, wherein selecting the first transmission configuration indicator state is based at least in part on receiving the control signaling enabling the UE to select the default transmission configuration indicator state for cross-carrier scheduling.

7. The apparatus of claim 1, wherein the instructions are further executable by the processor to cause the apparatus to:
select the first transmission configuration indicator state based at least in part on the determining, wherein the first physical cell identifier and the second physical cell identifier are the same, and wherein receiving the data transmission or the aperiodic channel state information transmission is based at least in part on the selecting.

8. The apparatus of claim 7, wherein the instructions to receive the control signaling are executable by the processor to cause the apparatus to:
receive a first downlink control information message comprising the indication of the first transmission configuration indicator state; and
receive a second downlink control information message comprising the grant of resources, wherein the first downlink control information message and the second downlink control information message support a unified transmission configuration indicator state configuration.

9. An apparatus for wireless communications at a network entity, comprising:
a processor;
memory coupled with the processor; and
instructions stored in the memory and executable by the processor to cause the apparatus to:
output control signaling on a first component carrier, the control signaling comprising an indication of a first transmission configuration indicator state and a grant of resources for outputting a data transmission or an aperiodic channel state information transmission on a second component carrier that is different from the first component carrier;
determine whether a first physical cell identifier associated with the first transmission configuration indicator state in an active bandwidth part of the second component carrier and a second physical cell identifier associated with a serving cell of the second component carrier are the same; and
output, via a first beam associated with the first transmission configuration indicator state based at least in part on the determining, the data transmission or the aperiodic channel state information transmission via the second component carrier according to the grant of resources.

10. The apparatus of claim 9, wherein the instructions are further executable by the processor to cause the apparatus to:
determine that a duration of time between outputting the control signaling and the granted resources does not satisfy a threshold time period, wherein the first physical cell identifier and the second physical cell identifier are not the same;
identify a plurality of beams associated with a plurality of transmission configuration indicator states comprising the first transmission configuration indicator state activated for the second component carrier, each of the plurality of transmission configuration indicator states corresponding to a respective index value of a plurality of index values; and
select the first beam associated with the first transmission configuration indicator state from the plurality of transmission configuration indicator states activated for the second component carrier based at least in part on the first transmission configuration indicator state corresponding to a lowest index value of the plurality of index values and the duration of time not satisfying the threshold time period.

11. The apparatus of claim 10, wherein the instructions are further executable by the processor to cause the apparatus to:
output, in the control signaling, an indication of the plurality of transmission configuration indicator states.

12. The apparatus of claim 10, wherein the first beam associated with the first transmission configuration indicator state to a plurality of component carriers of a carrier aggregation configuration comprising the first component carrier and the second component carrier based at least in part on the first transmission configuration indicator state corresponding to the lowest index value of the plurality of index values.

13. The apparatus of claim 10, wherein the instructions are further executable by the processor to cause the apparatus to:
output control signaling comprising an indication of the threshold time period.

14. The apparatus of claim 10, wherein the instructions are further executable by the processor to cause the apparatus to:
output control signaling enabling a user equipment (UE) to select a default transmission configuration indicator state for cross-carrier scheduling, wherein selecting the first transmission configuration indicator state is based at least in part on outputting the control signaling enabling the UE to select the default transmission configuration indicator state for cross-carrier scheduling.

15. The apparatus of claim 9, wherein the instructions are further executable by the processor to cause the apparatus to:
select the first beam associated with the first transmission configuration indicator state based at least in part on the determining, wherein the first physical cell identifier and the second physical cell identifier are the same, and wherein the outputting the data transmission or the aperiodic channel state information transmission via the first beam is based at least in part on the selecting.

16. The apparatus of claim 15, wherein the instructions to output the control signaling are executable by the processor to cause the apparatus to:
output a first downlink control information message comprising the indication of the first transmission configuration indicator state; and
output a second downlink control information message comprising the grant of resources, wherein the first downlink control information message and the second downlink control information message support a unified transmission configuration indicator state configuration.

17. A method for wireless communications at a user equipment (UE), comprising:
receiving control signaling on a first component carrier, the control signaling comprising an indication of a first transmission configuration indicator state and a grant of resources for receiving a data transmission or an aperiodic channel state information transmission on a second component carrier that is different from the first component carrier;
determining whether a first physical cell identifier associated with the first transmission configuration indicator state in an active bandwidth part of the second component carrier and a second physical cell identifier associated with a serving cell of the second component carrier are the same; and
receiving, via the first transmission configuration indicator state based at least in part on the determining, the data transmission or the aperiodic channel state information transmission via the second component carrier according to the grant of resources.

18. The method of claim 17, further comprising:
determining that a duration of time between receiving the control signaling and the granted resources does not satisfy a threshold time period, wherein the first physical cell identifier and the second physical cell identifier are not the same;
identifying a plurality of transmission configuration indicator states comprising the first transmission configuration indicator state activated for the second component carrier, each of the plurality of transmission configuration indicator states corresponding to a respective index value of a plurality of index values; and
selecting the first transmission configuration indicator state from the plurality of transmission configuration indicator states activated for the second component carrier based at least in part on the first transmission configuration indicator state corresponding to a lowest index value of the plurality of index values and the duration of time not satisfying the threshold time period.

19. The method of claim 18, further comprising:
applying the first transmission configuration indicator state to a plurality of component carriers of a carrier aggregation configuration comprising the first component carrier and the second component carrier based at least in part on the first transmission configuration indicator state corresponding to the lowest index value of the plurality of index values.

20. The method of claim 18, further comprising:
receiving control signaling comprising an indication of the threshold time period.

21. The method of claim 18, further comprising:
receiving control signaling enabling the UE to select a default transmission configuration indicator state for cross-carrier scheduling, wherein selecting the first transmission configuration indicator state is based at least in part on receiving the control signaling enabling the UE to select the default transmission configuration indicator state for cross-carrier scheduling.

22. The method of claim 17, further comprising:
selecting the first transmission configuration indicator state based at least in part on the determining, wherein the first physical cell identifier and the second physical cell identifier are the same, and wherein receiving the data transmission or the aperiodic channel state information transmission is based at least in part on the selecting.

23. The method of claim 22, wherein receiving the control signaling comprises:
receiving a first downlink control information message comprising the indication of the first transmission configuration indicator state; and
receiving a second downlink control information message comprising the grant of resources, wherein the first downlink control information message and the second downlink control information message support a unified transmission configuration indicator state configuration.

24. A method for wireless communications at a network entity, comprising:
outputting control signaling on a first component carrier, the control signaling comprising an indication of a first transmission configuration indicator state and a grant of resources for outputting a data transmission or an aperiodic channel state information transmission on a second component carrier that is different from the first component carrier;
determining whether a first physical cell identifier associated with the first transmission configuration indicator state in an active bandwidth part of the second component carrier and a second physical cell identifier associated with a serving cell of the second component carrier are the same; and
outputting, via a first beam associated with the first transmission configuration indicator state based at least in part on the determining, the data transmission or the aperiodic channel state information transmission via the second component carrier according to the grant of resources.

25. The method of claim 24, further comprising:
determining that a duration of time between outputting the control signaling and the granted resources does not satisfy a threshold time period, wherein the first physical cell identifier and the second physical cell identifier are not the same;
identifying a plurality of beams associated with a plurality of transmission configuration indicator states comprising the first transmission configuration indicator state activated for the second component carrier, each of the plurality of transmission configuration indicator states corresponding to a respective index value of a plurality of index values; and
selecting the first beam associated with the first transmission configuration indicator state from the plurality of transmission configuration indicator states activated for the second component carrier based at least in part on the first transmission configuration indicator state corresponding to a lowest index value of the plurality of index values and the duration of time not satisfying the threshold time period.

26. The method of claim 25, further comprising:
outputting, in the control signaling, an indication of the plurality of transmission configuration indicator states.

27. The method of claim 25, wherein the first beam associated with the first transmission configuration indicator state to a plurality of component carriers of a carrier aggregation configuration comprising the first component carrier and the second component carrier based at least in part on the first transmission configuration indicator state corresponding to the lowest index value of the plurality of index values.

28. The method of claim 25, further comprising:
outputting control signaling enabling a user equipment (UE) to select a default transmission configuration indicator state for cross-carrier scheduling, wherein selecting the first transmission configuration indicator state is based at least in part on outputting the control signaling enabling the UE to select the default transmission configuration indicator state for cross-carrier scheduling.

29. The method of claim 24, further comprising:
selecting the first beam associated with the first transmission configuration indicator state based at least in part on the determining, wherein the first physical cell identifier and the second physical cell identifier are the same, and wherein the outputting the data transmission or the aperiodic channel state information transmission via the first beam is based at least in part on the selecting.

30. The method of claim 29, wherein outputting the control signaling comprises:
outputting a first downlink control information message comprising the indication of the first transmission configuration indicator state; and
outputting a second downlink control information message comprising the grant of resources, wherein the first downlink control information message and the second downlink control information message support a unified transmission configuration indicator state configuration.
